(19) United States
(12) Patent Application Publication
(10) Pub. No.: US 2019/0050931 A1
(43) Pub. Date: Feb. 14, 2019

(54) NETWORK SYSTEM, INFORMATION PROCESSING METHOD, AND SERVER

(71) Applicant: SHARP KABUSHIKI KAISHA, Sakai City (JP)

(72) Inventors: TAKAYUKI NAGAMATSU, Sakai City (JP); MASAKI TAKEUCHI, Sakai City (JP); TOMOKO MUGURUMA, Sakai City (JP)

(21) Appl. No.: 16/059,947

(22) Filed: Aug. 9, 2018

(30) Foreign Application Priority Data
Aug. 10, 2017 (JP) 2017-155555

(51) Int. Cl. G06Q 30/06; G10L 15/22; G06F 3/16; G10L 15/30

(52) U.S. Cl. CPC G06Q 30/0633; G10L 15/22; G06Q 30/0603; G10L 2015/223; G06Q 30/0643; G06F 3/167; G10L 15/30; G06Q 30/0631

(57) ABSTRACT

Provided herein is a network system that includes: a first terminal that includes a speaker; a second terminal that includes a display; and a server that causes the first terminal to output an audio, and that causes the second terminal to display an image concerning the audio.

### BACKGROUND OF THE INVENTION

### Field of the Invention

The present invention relates to technology for a network system, an information processing method, and a server for exchanging a voice message with a user.

### Description of the Related Art

A technology is known that outputs a message suited for a user. For example, WO2016/088597 discloses a food management system, a refrigerator, a server, a terminal device, and a control program. In the food management system of this related art, a server detects the presence of a user near a refrigerator. The server generates a message based on an order from a user, and stores it in a memory. The message is read out from the memory, and forwarded to a refrigerator at the time of detection. After forwarding the message, the server accepts a food order from the refrigerator for a preset specified time period. In this way, the food management system including the refrigerator is able to effectively send information to a user.

### SUMMARY OF INVENTION

An object of the present invention is to provide a voice interaction technique with which information can be more smoothly sent to a user.

According to a certain aspect of the present invention, there is provided a network system that includes: a first terminal that includes a speaker; a second terminal that includes a display; and a server that causes the first terminal to output an audio, and that causes the second terminal to display an image concerning the audio.

The present invention has enabled providing a voice interaction technique with which information can be more smoothly sent to a user.

### BRIEF DESCRIPTION OF THE DRAWINGS

FIG. 1 is a diagram showing an overall configuration of a network system 1 according to First Embodiment, and a first brief overview of its operation.

FIGS. 2A and 2B are diagrams showing a screen of a store communication terminal 300 of the network system 1 according to First Embodiment.

FIG. 3 is a block diagram representing a configuration of a server 100 according to First Embodiment.

FIG. 4 is a diagram representing terminal data 121 according to First Embodiment.

FIG. 5 is a diagram representing product data 122 according to First Embodiment.

FIG. 6 is a diagram representing store data 123 according to First Embodiment.

FIG. 7 is a diagram representing stock data 124 according to First Embodiment.

FIG. 8 is a diagram representing order data 125 according to First Embodiment.

FIG. 9 is a diagram representing an information process by the server 100 according to First Embodiment.

FIG. 10 is a block diagram representing a configuration of a customer communication terminal 200 according to First Embodiment.

FIG. 11 is a block diagram representing a configuration of a store communication terminal 300 according to First Embodiment.

FIG. 12 is a diagram showing an overall configuration of a network system 1 according to Second Embodiment, and a first brief overview of its operation.

FIG. 13 is a diagram representing an information process by the server 100 according to Second Embodiment.

FIG. 14 is a diagram showing an overall configuration of a network system 1 according to Third Embodiment, and a first brief overview of its operation.

FIG. 15 is a diagram representing an information process by the server 100 according to Third Embodiment.

FIG. 16 is a diagram showing an overall configuration of a network system 1 according to Fourth Embodiment, and a first brief overview of its operation.

FIG. 17 is a diagram representing an information process by the server 100 according to Fourth Embodiment.

FIG. 18 is a diagram showing an overall configuration of a network system 1 according to Fifth Embodiment, and a first brief overview of its operation.

FIG. 19 is a diagram representing product data 122B according to Fifth Embodiment.

FIG. 20 is a diagram representing feedback data 126 according to Fifth Embodiment.

FIG. 21 is a diagram representing an information process by the server 100 according to Fifth Embodiment.

FIG. 22 is a diagram showing a screen of a store communication terminal 300 of a network system 1 according to Sixth Embodiment.

FIG. 23 is a diagram representing an information process by the server 100 according to Sixth Embodiment.

FIG. 24 is a diagram showing a screen of a store communication terminal 300 of a network system 1 according to Seventh Embodiment.

FIG. 25 is a diagram representing an information process by the server 100 according to Seventh Embodiment.

FIG. 26 is a diagram showing an overall configuration of a network system 1 according to Eighth Embodiment, and a first brief overview of its operation.

FIG. 27 is a diagram representing nearby display data 127 according to Eighth Embodiment.

FIG. 28 is a diagram representing an information process by the server 100 according to Eighth Embodiment.

FIG. 29 is a block diagram representing a configuration of a television 400 according to Eighth Embodiment.

FIG. 30 is a diagram showing an overall configuration of a network system 1 according to Ninth Embodiment, and a first brief overview of its operation.

FIG. 31 is a diagram representing product data 122C according to Ninth Embodiment.

FIG. 32 is a diagram representing an information process by the server 100 according to Ninth Embodiment.

FIG. 33 is a diagram representing an information process by the server 100 according to Tenth Embodiment.

FIG. 34 is a diagram representing an information process by the server 100 according to Eleventh Embodiment.

FIG. 35 is a diagram representing an information process by the server 100 according to Twelfth Embodiment.

FIGS. 36A to 36C are diagrams showing an overall configuration of a network system 1 according to Twelfth Embodiment, and a first brief overview of its operation.

FIGS. 37A to 37C are diagrams showing an overall configuration of the network system 1 according to Twelfth Embodiment, and a second brief overview of its operation.

FIG. 38 is a diagram representing a first information process by the server 100 according to Twelfth Embodiment.

FIGS. 39A to 39C are diagrams showing an overall configuration of the network system 1 according to Twelfth Embodiment, and a third brief overview of its operation.

FIG. 40 is a diagram representing a second information process by the server 100 according to Twelfth Embodiment.

FIG. 41 is a diagram showing an overall configuration of a network system 1 according to Thirteenth Embodiment, and a first brief overview of its operation.

FIG. 42 is a diagram representing audio-video data 128 according to Thirteenth Embodiment.

### DESCRIPTION OF THE PREFERRED EMBODIMENTS

Embodiments of the present invention are described below with reference to the accompanying drawings. In the following descriptions, like elements are given like reference numerals. Such like elements will be referred to by the same names, and have the same functions. Accordingly, detailed descriptions of such elements will not be repeated.

### First Embodiment

### Overall Configuration of Network System 1

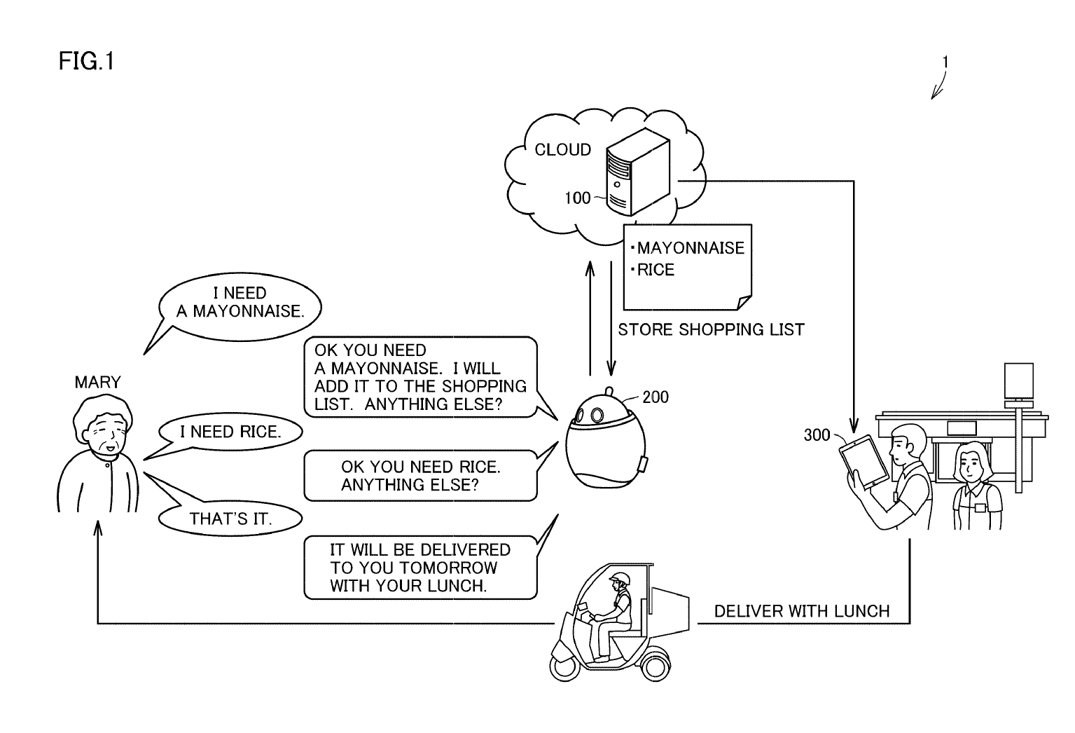

An overall configuration of a network system 1 according to an embodiment of the invention is described below, with reference to FIG. 1. A network system 1 according to the present embodiment includes, mainly, a server 100 for interaction service, a customer communication terminal 200, such as a robot, disposed at homes and offices, and a store communication terminal 300, such as a tablet, disposed n various stores and business offices.

The customer communication terminal 200 and the store communication terminal 300 are not limited to robots and tablets, and may be a variety of other devices, including, for example, home appliances such as refrigerators, microwave ovens, air conditioners, washing machines, vacuum cleaners, air purifiers, humidifiers, dehumidifiers, rice cookers, and illumination lights; AV (audio-visual) devices such as portable phones, smartphones, televisions, hard disk recorders, projectors, music players, gaming machines, and personal computers; and household equipment such as embedded lightings, photovoltaic generators, intercoms, water heaters, and a controller for electronic bidets.

### Brief Overview of Operation of Network System 1

The following is a brief overview of the operation of the network system 1. Referring to FIG. 1, the customer communication terminal 200 interacts with a user, using data from the server 100. Specifically, the customer communication terminal 200 outputs an audio using audio data from the server 100, receives an audio from a user and sends it to the server 100, and outputs an audio using audio data from the server 100, in a repeated fashion.

In the present embodiment, the operation of the customer communication terminal 200 includes, for example, accepting a user's order for products and services and forwarding the order to the server 100, and accepting a suggestion message from the server 100 with regard to products and services and outputting the message as a voice message. Parties involved in the network system 1 provide various services, including shipping products from a delivery center in response to orders accepted by the server 100, delivering products to a user's home from a store located near the user of the customer communication terminal 200, and having a service provider visit users' homes.

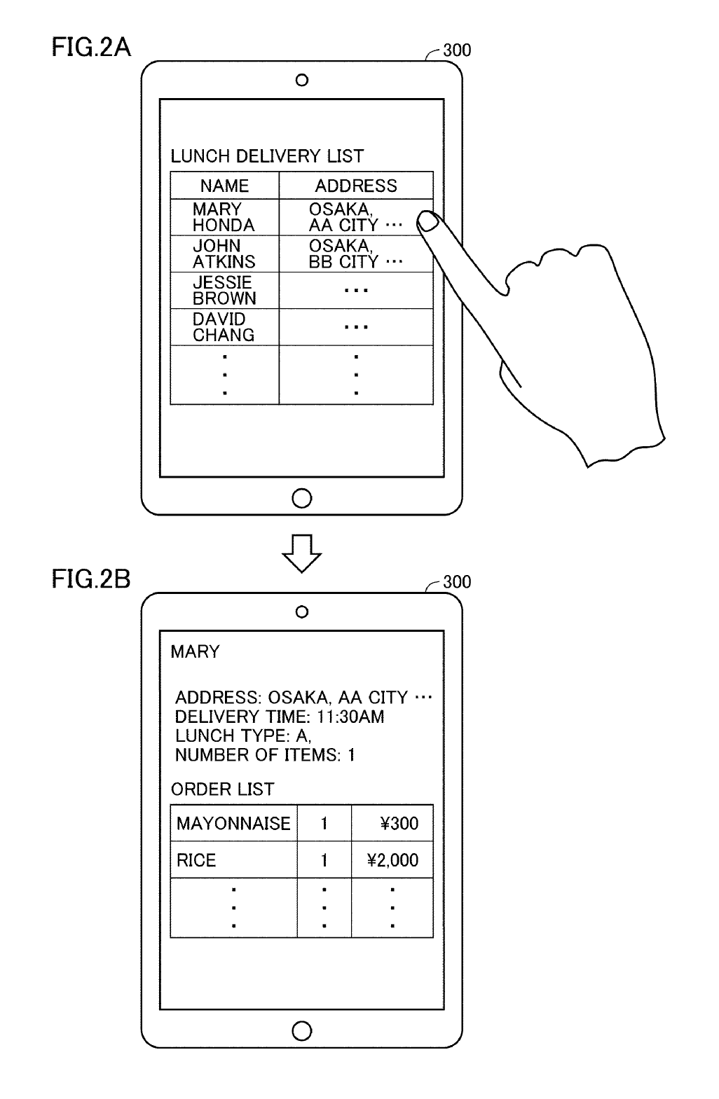

For services that offer delivery of products to users' homes on a regular basis, for example, as in the case of lunch delivery, a user is preferably recommended to place an order for products for the next delivery. In the present embodiment, the store communication terminal 300 receiving an order for regular lunch delivery displays lists of customers and products for next delivery, using data from the server 100, as shown in FIGS. 2A and 2B. More specifically, as shown in FIG. 2A, the store communication terminal 300 selectably displays a list of delivery addresses, using data from the server 100. As shown in FIG. 2B, the store communication terminal 300 also displays a list of products to be delivered to the selected address, using data from the server 100.

Preferably, the server 100 displays lists of delivery addresses and products in the store communication terminal 300 at a predetermined time before the customer's delivery time, for example, one hour in advance.

In this manner, in the interaction service according to the present embodiment, a user is able to conveniently place an order for products by way of a voice interaction through the customer communication terminal 200, and a store can deliver more than one product at once. The following describes the network system 1 with regard to spec fic configurations that achieve these functions.

### Hardware Configuration of Server 100 for Interaction Service

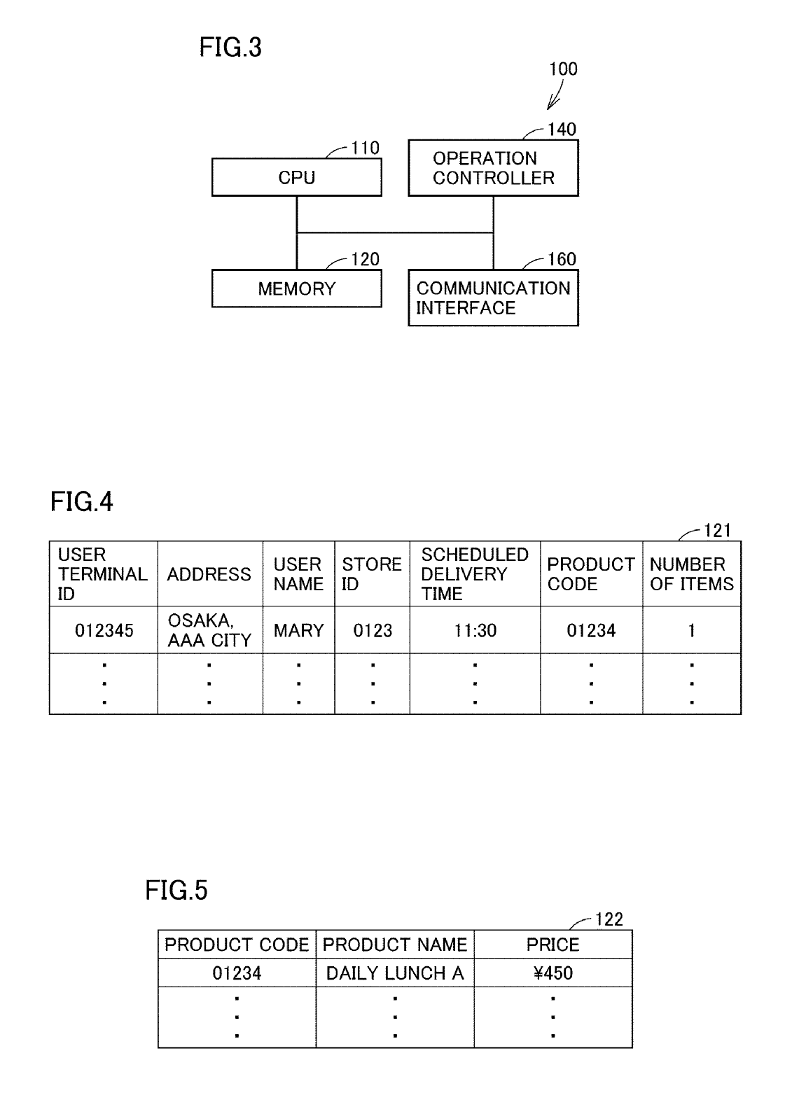

An aspect of the hardware configuration of the server 100 for interaction service constituting the network system 1 according to the present embodiment is described first. Referring to FIG. 3, the main constituting elements of the server 100 for interaction service include a CPU (Central Processing Unit) 110, a memory 120, an operation controller 140, and a communication interface 160.

The CPU 110 controls different parts of the server 100 for interaction service by executing the programs stored in the memory 120. For example, the CPU 110 executes the programs stored in the memory 120, and performs various processes (described later) by referring to various data. Preferably, the CPU 110 enables AI (Artificial Intelligence) functions, and performs an AI-based voice interaction.

The memory 120 is realized by, for example, various types of RAMs (Random Access Memory) and ROMs (Read-Only Memory). The memory 120 stores various data, including the programs run by the CPU 110, data generated by execution of programs by the CPU 110, and input data from the operation controller 140. For example, the memory 120 stores terminal data 121, product data 122, store data 123, stock data 124, and order data 125. Evidently, these data are not necessarily required to be stored in the server 100 for interaction service itself, and may be stored in other devices that can be accessed by the server 100.

Referring to FIG. 4, the terminal data 121 contains terminal IDs, addresses, user names, information for specifying nearby stores, scheduled delivery times, information for specifying the products that are in need of regular delivery, and the number of products to be delivered on a regular basis. These are associated with one another, and are stored for each customer communication terminal 200, such as a robot.

Referring to FIG. 5, the product data 122 contains product codes, product names, and product prices, which are associated with one another, and are stored for each product.

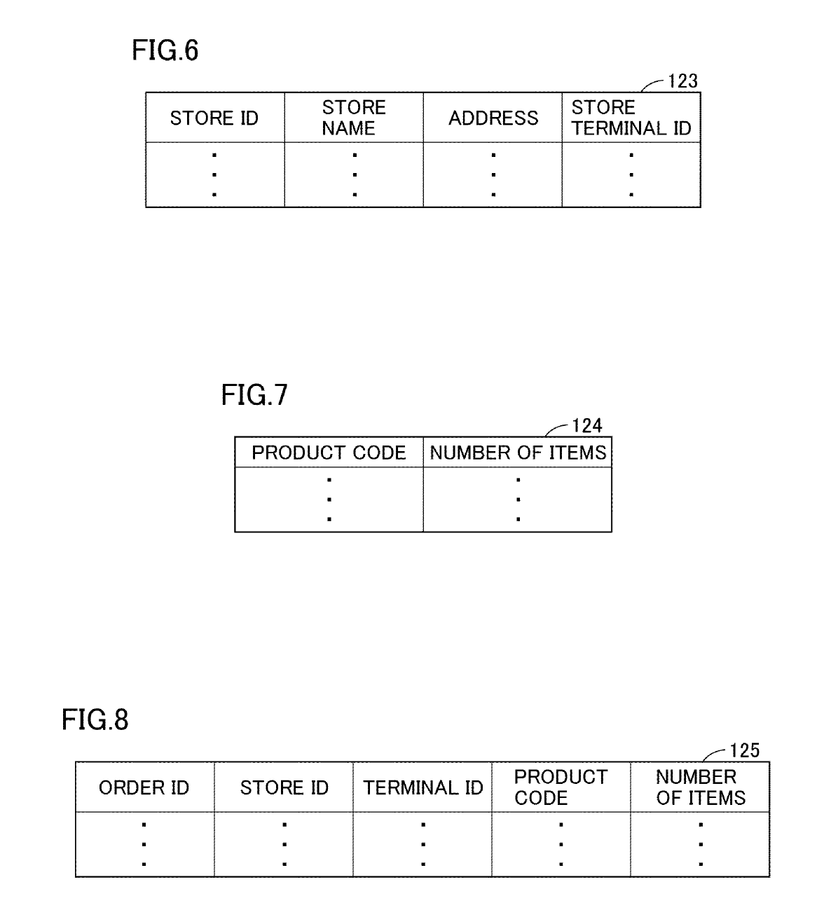

Referring to FIG. 6, the store data 123 contains store IDs, store names, store addresses, and IDs of store communication terminals 300, which are associated with one another, and are stored for each store.

Referring to FIG. 7, the stock data 124 is prepared for each store. The stock data 124 contains product codes, and the number of products in stock at the store. These are associated with one another, and are stored for each store.

Referring to FIG. 8, the order data 125 contains order IDs, IDs of stores to deliver products, IDs of customer communication terminals 200 that have placed orders, codes of ordered products, and the number of ordered products. These are associated with one another, and are stored for each accepted order. For example, the CPU 110 specifies a user's order using audio data received from the customer communication terminal 200 via the communication interface 160, and adds the order to the order data 125.

Referring back to FIG. 3, the operation controller 140 accepts instructions from, for example, a service administrator, and inputs the instructions to the CPU 110.

The communication interface 160 sends data from the CPU 110 to other devices, including the customer communication terminal 200 and the store communication terminal 300, via, for example, the Internet, a carrier network, and a router. Conversely, the communication interface 160 receives data from other devices via, for example, the Internet, a carrier network, and a router, and passes it to the CPU 110.

### Information Process in Server 100 for Interaction Service

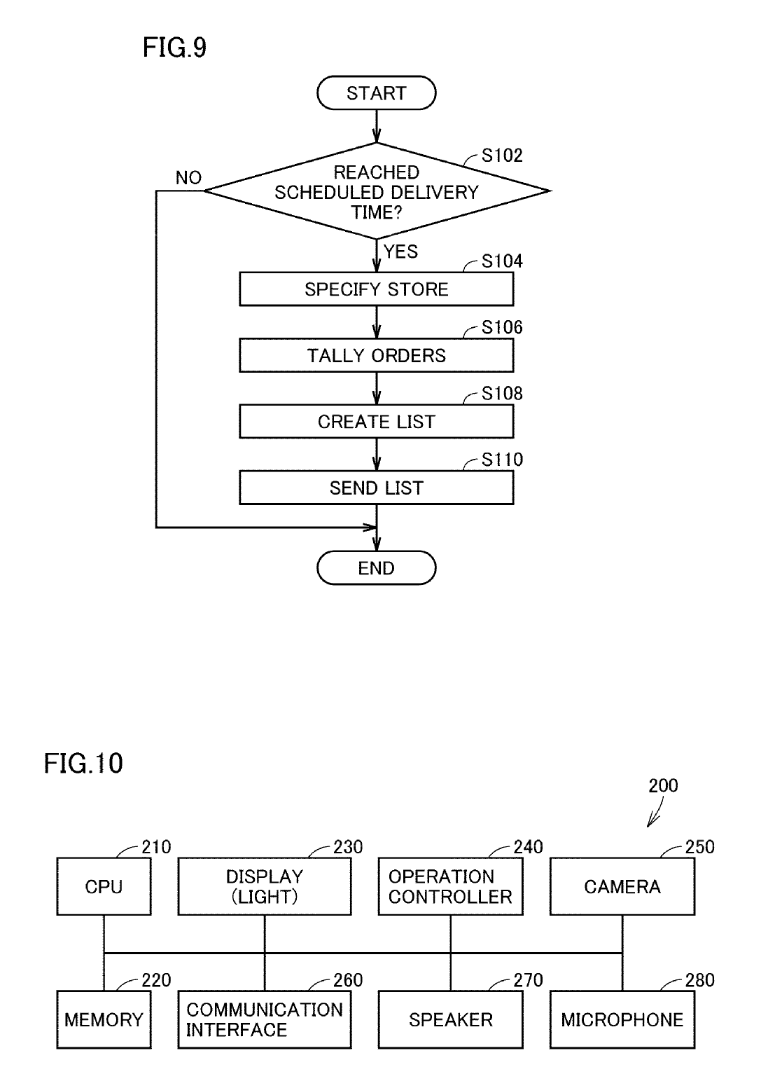

The following describes the information process in the server 100 for interaction service according to the present embodiment, with reference to FIG. 9. In the present embodiment, the CPU 110 of the server 100 performs the following processes on a regular basis.

By referring to the terminal data 121, the CPU 110 of the server 100 determines the presence or absence of a customer communication terminal 200 that has reached the scheduled delivery time (step S102). The CPU 110 puts itself on standby for the next timing in the absence of a customer communication terminal 200 that has reached the scheduled delivery time (NO in step S102).

As used herein, “delivery time” as a predetermined timing indicates the time when stores and shipping centers start preparing for a delivery of products. However, the delivery time as a predetermined timing may be the time of the actual shipment from a store or a shipping center. In this case, the CPU 110 in step S102 determines whether the time left before the predetermined delivery time is less than 30 minutes or an hour. Alternatively, the delivery time as a predetermined timing may be the actual time when the product arrives the user's home. In this case, the CPU 110 in step S102 determines whether the time left before the predetermined delivery time is less than an hour or two hours.

In the presence of a customer communication terminal 200 that has reached the scheduled delivery (YES in step S102), the CPU 110 refers to the terminal data 121, and specifies a store associated with the customer communication terminal 200 (step S104). The CPU 110, by referring to the order data 125 tallies orders placed after the previous delivery (step S106). Using the tally result, the CPU 110 generates a delivery list (step S108). The CPU 110 sends the delivery list to the communication terminal of the store associated with the user's communication terminal, via the communication interface 160 (step S110). The CPU 110 then puts itself on standby for the next timing.

In response, the communication terminal of the store displays a delivery address list as shown in FIG. 2A, and a product list as shown in FIG. 2B. The method of payment for the ordered products and services is not particularly limited.

### Hardware Configuration of Customer Communication Terminal 200

An aspect of the configuration of the customer communication terminal 200 constituting the network system 1 is described below, with reference to FIG. 10. The main constituting elements of the customer communication terminal 200 includes a CPU 210, a memory 220, a display 230, an operation controller 240, a camera 250, a communication interface 260, a speaker 270, and a microphone 280.

The CPU 210 controls different parts of the customer communication terminal 200 by executing the programs stored in the memory 220 or in an external storage medium.

The memory 220 is realized by, for example, various types of RAMs and ROMs. The memory 220 stores various data, including programs run by the CPU 210, for example, such as device activation programs and interaction programs, data generated by execution of programs by the CPU 210, data received from the server 100 for interaction service or other servers, and input data via the operation controller 240.

The display 230 outputs information in the form of, for example, texts and images, based on signals from the CPU 210. The display 230 may be, for example, a plurality of LED lights.

The operation controller 240 is realized by, for example, buttons, and a touch panel. The operation controller 240 accepts user instructions, and inputs the instructions to the CPU 210. The display 230 and the operation controller 240 may constitute a touch panel.

The operation controller 240 may be, for example, a proximity sensor or a temperature sensor. In this case, the CPU 210 starts various processes upon the operation controller 240—a proximity sensor or a temperature sensor—detecting that a user has placed his or her hand over the customer communication terminal 200, for example, a robot. For example, a proximity sensor may be disposed near the forehead of the robot, and a user stroking or patting the forehead may be detected by the robot (customer communication terminal 200).

The camera 250 captures image, and passes the image data to the CPU 210.

The communication interface 260 is realized by a communication module, for example, such as wireless LAN communications, and a wired LAN. The communication interface 260 enables data exchange with other devices, including the server 100 for interaction service, via wired or wireless communications.

The speaker 270 outputs an audio based on signals from the CPU 210. Specifically, in the present embodiment, the CPU 210 makes the speaker 270 output a voice message based on the audio data received from the server 100 via the communication interface 260. Alternatively, the CPU 210 creates an audio signal from text data received from the server 100 via the communication interface 260, and makes the speaker 270 output a voice message. Alternatively, the CPU 210 reads out audio message data from the memory 220 using the message ID received from the server 100 via the communication interface 260, and makes the speaker 270 output a voice message.

The microphone 280 creates an audio signal based on an externally input audio, and inputs the audio signal to the CPU 210. The audio accepted by the CPU 210 via the microphone 280 is sent to the sever 100 via the communication interface 260. For example, a user's order for products and services entered via the microphone 280 is sent from the CPU 210 to the server 100 via the communication interface 260.

### Hardware Configuration of Store Communication Terminal 300

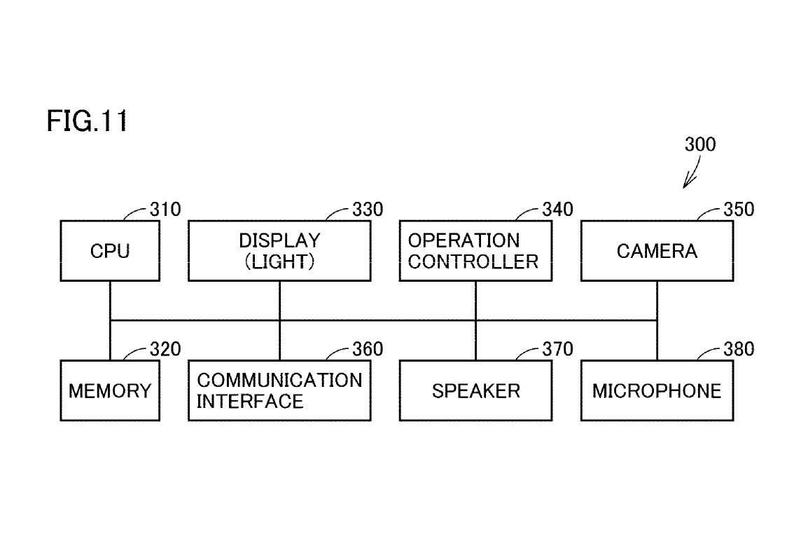

An aspect of the hardware configuration of the store communication terminal 300 disposed in places such as a convenience store is described below. Referring to FIG. 11, the main constituting elements of the store communication terminal 300 include a CPU 310, a memory 320, a display 330, an operation controller 340, and a communication interface 360.

The CPU 310 controls different parts of the store communication terminal 300 by executing the programs stored in the memory 320.

The memory 320 is realized by, for example, various types of RAMs and ROMs. The memory 320 stores various data, including the programs run by the CPU 310, data generated by execution of programs by the CPU 310, input data, and data obtained from the server 100. Evidently, these data are not necessarily required to be stored in the store communication terminal 300 itself, and may be stored in other devices that can be accessed by the store communication terminal 300.

The display 330 displays information in the form of, for example, images and texts, based on signals from the CPU 310. The operation controller 340 is co-figured from, for example, a keyboard and switches. The operation controller 340 accepts instructions from an operator, and inputs the instructions to the CPU 310. The display 330 and the operation controller 340 may constitute a touch panel.

The communication interface 360 is realized by a communication module such as wireless LAN communications, and a wired LAN. The communication interface 360 enables data exchange with other devices, including the server 100 for interaction service, via wired or wireless communications.

For example, the CPU 310 causes the display 230 to display a delivery address list as shown in FIG. 2A, using the delivery address list received from the server 100 via the communication interface 360. The CPU 310 causes the display 230 to display an order list from a delivery address as shown in FIG. 2B, using the order list received from the server 100 via the communication interface 360.

### Second Embodiment

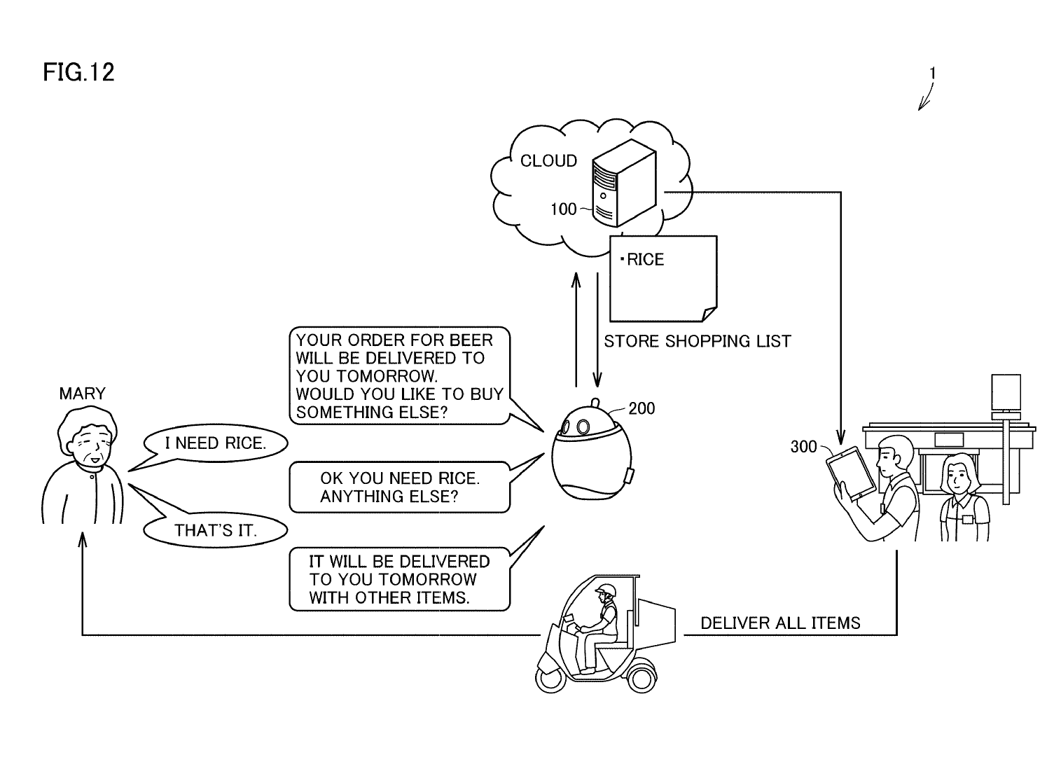

First Embodiment described a scheduled delivery of products from a store where the products ordered before the scheduled delivery time are delivered at once. Additionally, a service provider may regularly recommend a user to order products to be delivered with other products at the time of next delivery, as shown in FIG. 12. The processes after reaching the scheduled delivery time are as described in First Embodiment.

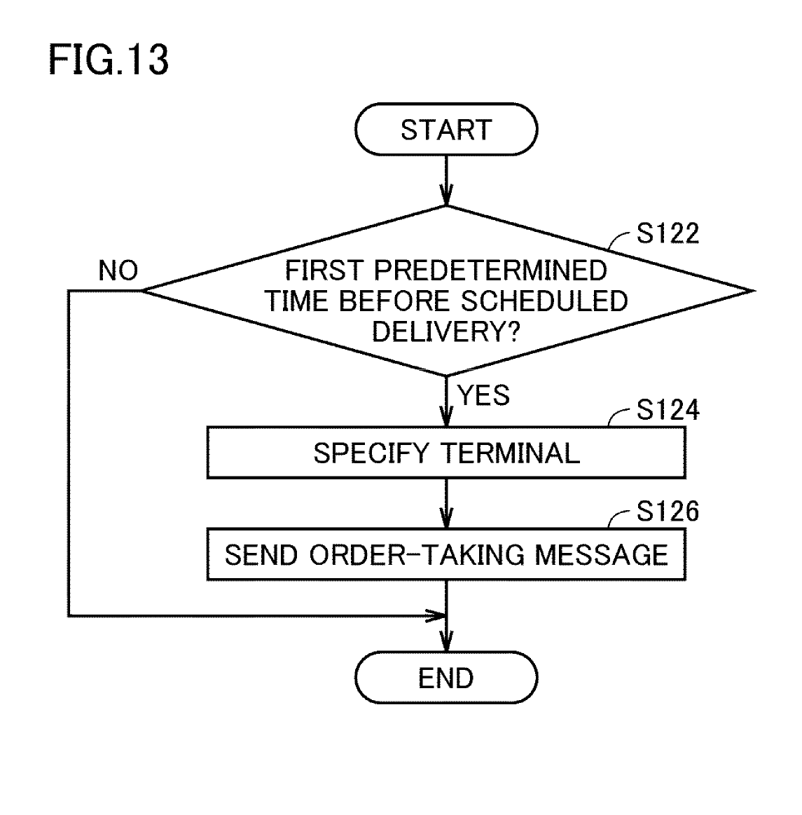

In the present embodiment, the CPU 110 of the server 100 additionally performs the following process on a regular basis, as represented in FIG. 13. The CPU 110 of the server 100 refers to the terminal data 121, and determines the presence or absence of a customer communication terminal 200 that has reached a first predetermined time, for example, 3 hours before the scheduled delivery time (step S122). The CPU 110 puts itself on standby for the next timing in the absence of a customer communication terminal 200 that has reached a first predetermined time before the scheduled delivery time (NO in step S122).

In the presence of a customer communication terminal 200 that has reached a first predetermined time before the scheduled delivery time (YES in step S122), the CPU 110 specifies the customer communication terminal 200 (step S124), and sends an order-taking message for a user to the customer communication terminal 200 via the communication interface 160 (step S126). The CPU 110 then puts itself on standby for the next timing.

In this manner, the customer communication terminal 200 can take orders as shown in FIG. 12. For example, a user can be reminded of forgotten orders and purchases by the robot suggesting a purchase of products and services.

### Third Embodiment

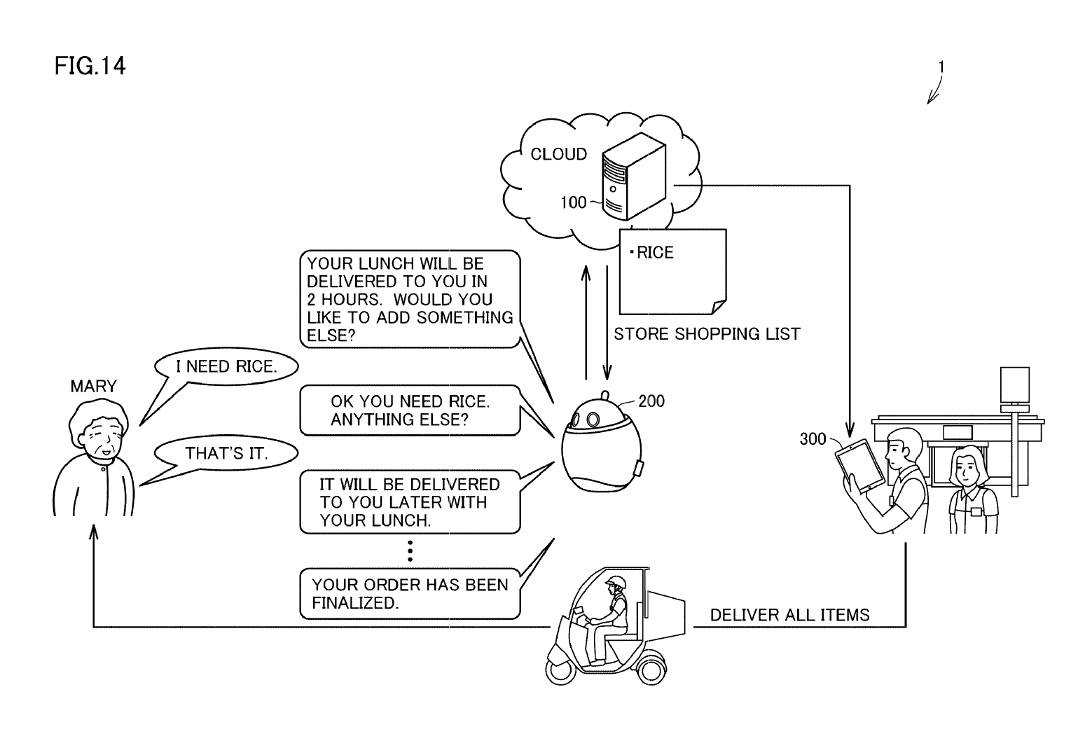

A user is preferably informed of finalization of orders for the next delivery, as shown in FIG. 14. For example, the customer communication terminal 200 outputs a voice message that “your orders have been finalized”. The processes after reaching the scheduled delivery time are the same as in First Embodiment.

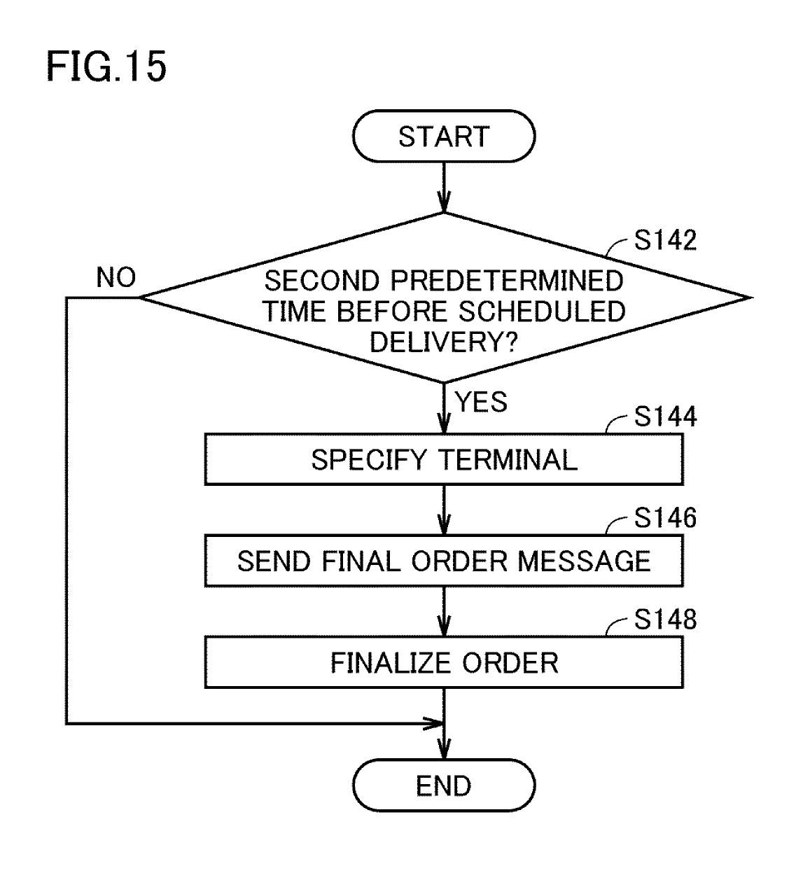

In the present embodiment, the CPU 110 of the server 100 performs the following process on a regular basis, as represented in FIG. 15. By referring to the terminal data 121, the CPU 110 of the server 100 determines the presence or absence of a customer communication terminal 200 that has reached a second predetermined time, for example, 1 hour or 30 minutes before the scheduled delivery time (step S142). The CPU 110 puts itself on standby for the next timing in the absence of a customer communication terminal 200 that has reached a second predetermined time before the scheduled delivery time (NO in step S142).

In the presence of a customer communication terminal 200 that has reached a second predetermined time before the scheduled delivery time (YES in step S142), the CPU 110 specifies the customer communication terminal 200 (step S144), and finalizes the currently placed orders (step S148) by sending the customer communication terminal 200 information that the current orders will be finalized, via the communication interface 160 (step S146). The CPU 110 may send the customer communication terminal 200 information that any new order will not be accepted for the next delivery, via the communication interface 160.

In the present embodiment, the CPU 110 stores an order in the order data 125 when it is finalized. However, an order may be stored in the order data 125 when the user has placed an order, and a finalization flag associated with an order ID may be created when the order is finalized. The CPU 110 puts itself on standby for the next timing.

After step S148, the CPU 110 may start the process of FIG. 9, or the processes of steps S108 and S110.

In this manner, the customer communication terminal 200 can send a user a message that the currently placed orders have been formally finalized, or a message that any new order will not be accepted for the next delivery, as shown in FIG. 14.

### Fourth Embodiment

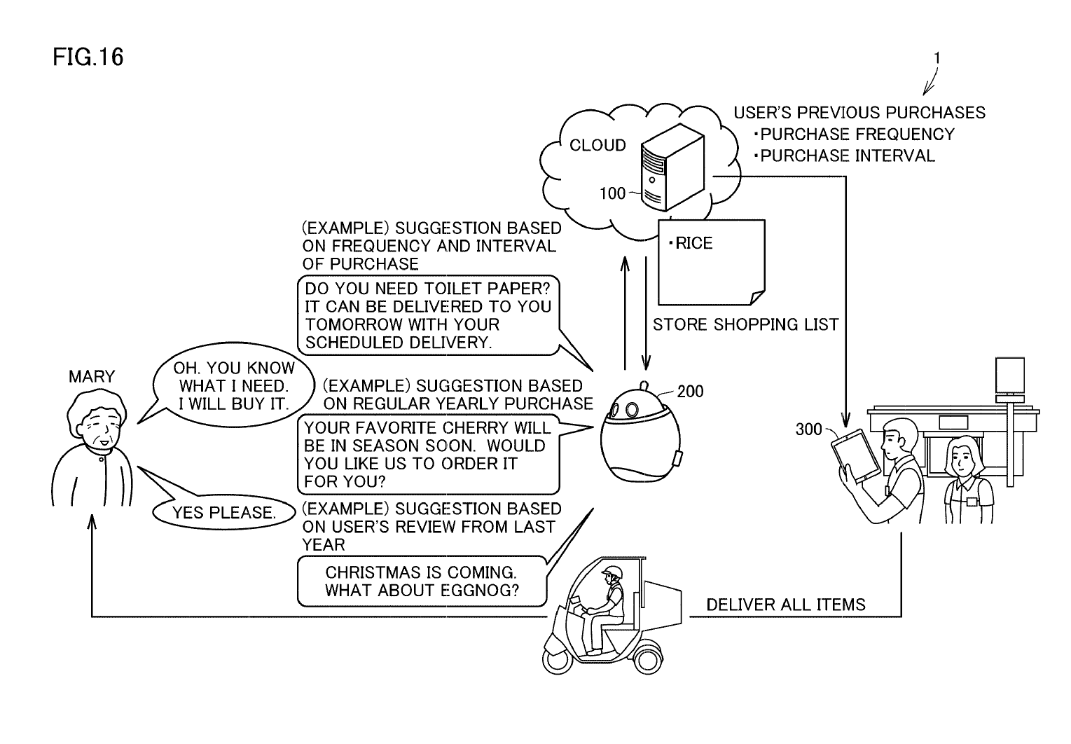

The server 100 may suggest buying products and services to a user via the customer communication terminal 200, using information such as previous purchases of the user, availability of products and services in a store, and use-by dates, as shown in FIG. 16. The processes after reaching the scheduled delivery time are the same as in First Embodiment.

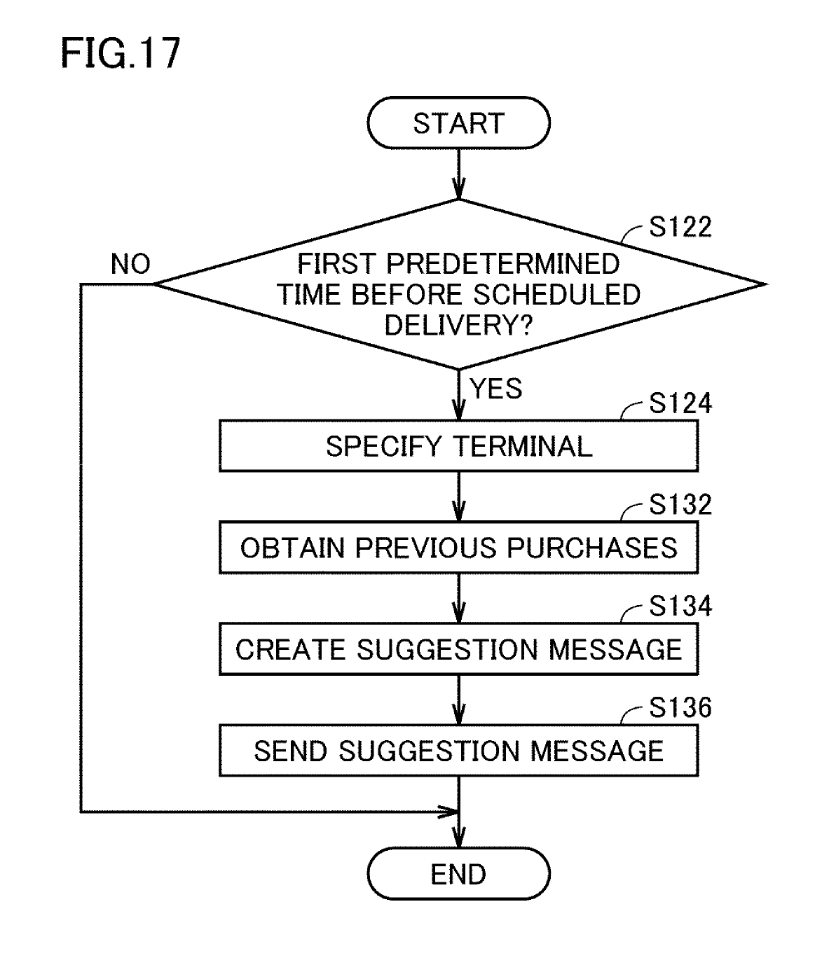

In the present embodiment, the CPU 110 of the server 100, by referring to the terminal data 121, additionally determines the presence or absence of a customer communication terminal 200 that has reached a first predetermined time, for example, 2 hours before the scheduled delivery time, as shown in FIG. 17 (step S122). The CPU 110 puts itself on standby for the next timing in the absence of a customer communication terminal 200 that has reached a first predetermined time before the scheduled delivery time (NO in step S122).

The CPU 110 specifies the customer communication terminal 200 (step S124) in the presence of a customer communication terminal 200 that has reached a first predetermined time before the scheduled delivery time (YES in step S122). By referring to the order data 125, the CPU 110 obtains the previous purchases made by the user of the customer communication terminal 200 (step S132). By using the previous purchase information, the CPU 110 creates a message that suggests the user buy products and services (step S134).

For example, as shown in FIG. 16, the CPU 110 suggests a purchase of products that may be running out, using the user's purchase frequency and purchase intervals. Alternatively, the CPU 110 suggests buying a seasonally purchased product when the season comes. By referring to, for example, feedback data (described later), the CPU 110 may also suggest products having high ratings from the user. The suggestions are not limited to products, and the CPU 110 may suggest services such as massage, tuning of musical instruments, and waxing, using the user's past orders.

Referring back to FIG. 17, the CPU 110 in step S134 may create a suggestion message that suggests a purchase of products having high availability in the store associated with the user, using the stock data 124.

The CPU 110 sends the suggestion message to the user's communication terminal via the communication interface 160 (step S136). The CPU 110 then puts itself on standby for the next timing.

In this manner, the customer communication terminal 200 can recommend placing an order for products and services suited for a user, as shown in FIG. 16.

### Fifth Embodiment

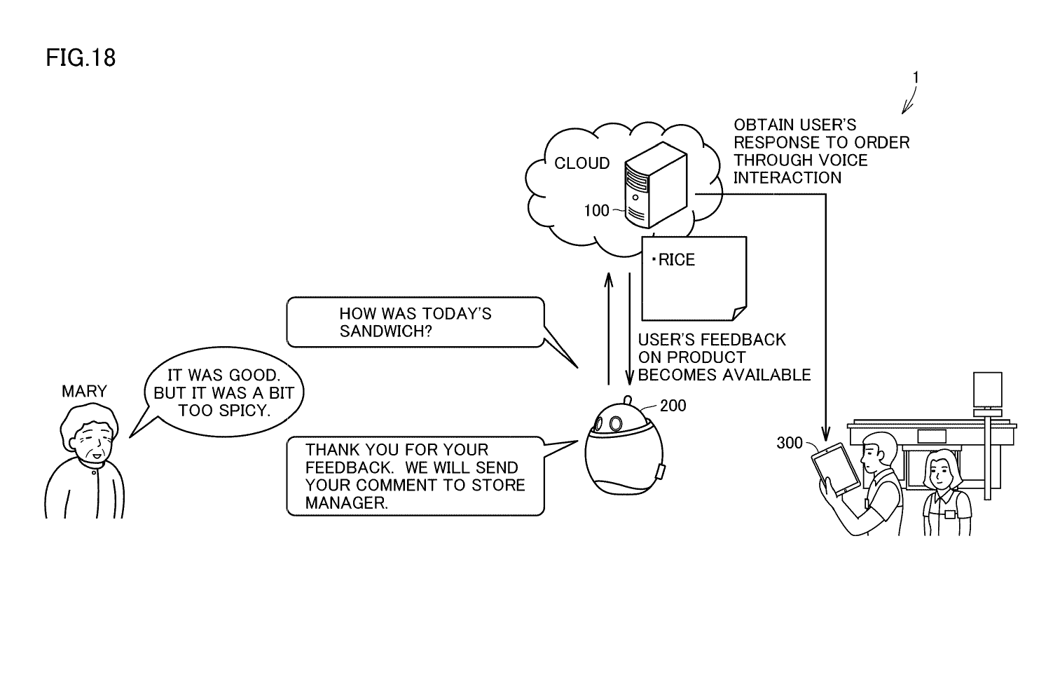

In a preferred embodiment, the server 100 is able to obtain, via the customer communication terminal 200, reviews from users concerning the products and services purchased by the users, as shown in FIG. 18. The processes after reaching the scheduled delivery time are the same as in First Embodiment.

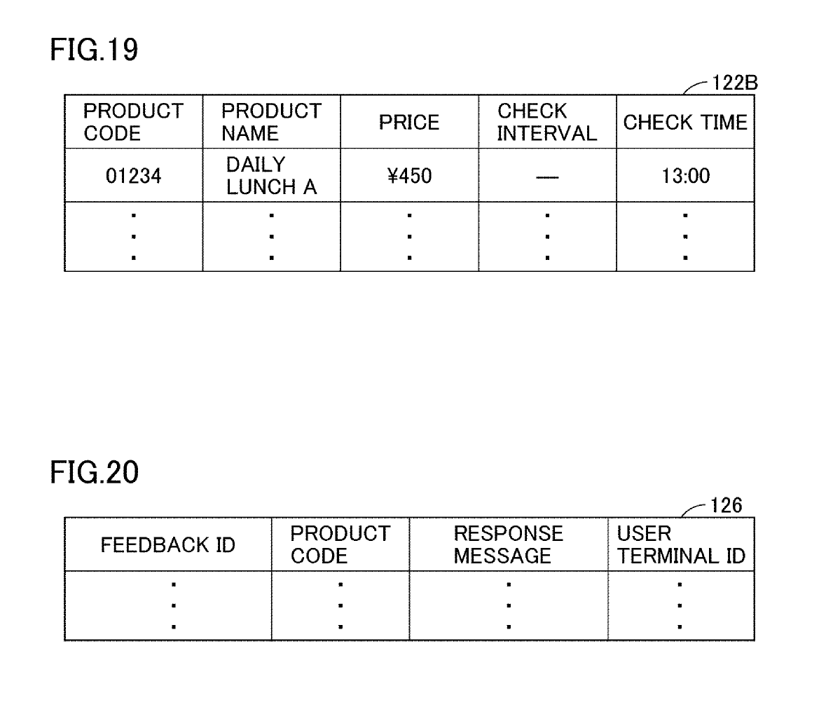

In the present embodiment, as shown in FIG. 19, the product data 122B contains product codes, product names, product prices, the time interval before asking for a user review after the delivery, and the time for asking a user for a review. These are associated with one another, and are stored for each product.

In the present embodiment, the memory 120 stores the feedback data 126, as shown in FIG. 20. The feedback data 126 contains feedback IDs, the codes of products of interest, response messages from users, and the IDs of customer communication terminals 200 of users who have provided reviews. These are associated with one another, and are stored for each user review.

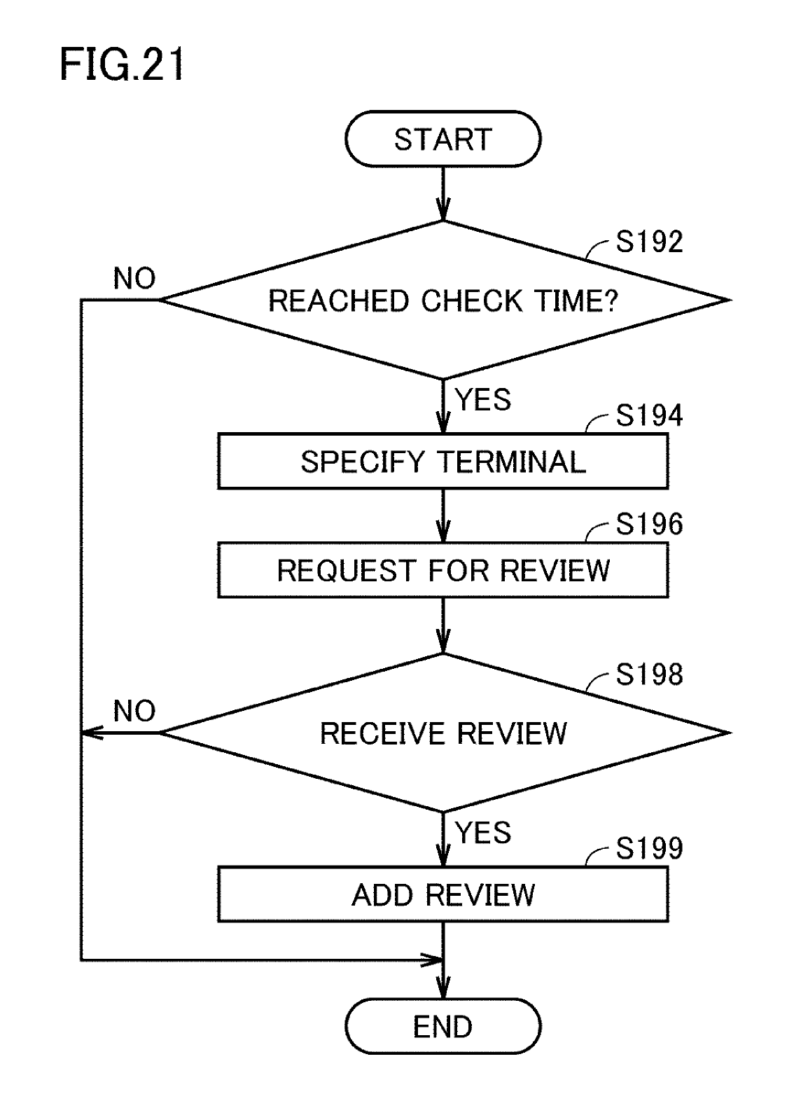

In the present embodiment, the CPU 110 of the server 100 performs the following process on a regular basis, as represented in FIG. 21. By referring to the terminal data 121, the CPU 110 of the server 100 determines the presence or absence of a customer communication terminal 200 that has reached the time for checking for a user review (step S192). The CPU 110 puts itself on standby for the next timing in the absence of a customer communication terminal 200 that has reached the time for checking for a user review (NO in step S192).

In the presence of a customer communication terminal 200 that has reached the time for checking for a user review (YES in step S192), the CPU 110 specifies the customer communication terminal 200 (step S194), and asks for a review of the delivered product, via the communication interface 160 (step S196). In response, as shown in FIG. 18, the user's communication terminal asks the user to review the purchased product. For example, the time to ask for a review is preferably about 2 hours after the delivery for items such as a lunch, about 24 hours after the delivery for items such as instant food products, and about 1 month after the delivery for items such as clothing.

The CPU 110 accepts a user review from the customer communication terminal 200 via the communication interface 160 (YES in step S198), and adds the review to the feedback data 126 (step S199).

The feedback data 126 are used by servers and service administrators to find, for example, the tastes of customers, and popular products and services.

### Sixth Embodiment

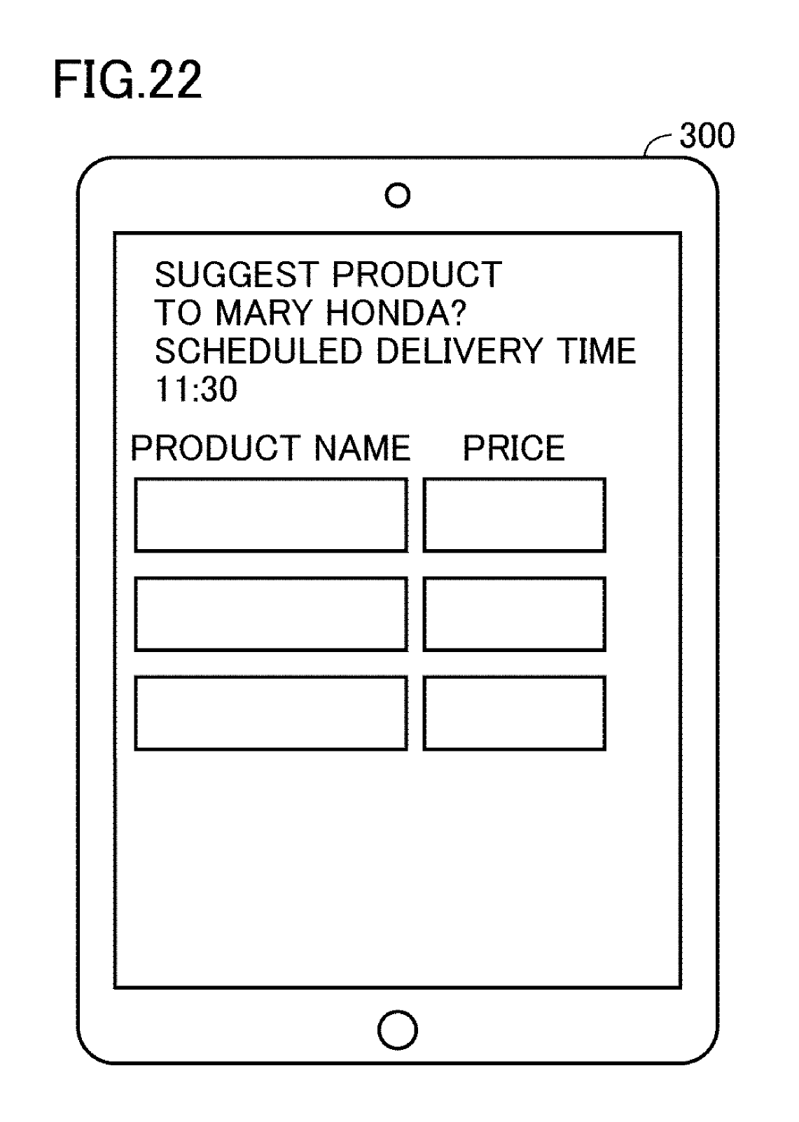

The network systems 1 of First to Fifth Embodiments may be adapted so that, for example, staff members of a store are allowed to specify products and services, and suggest the specified products and services to a user, as shown in FIG. 22. The processes after reaching the scheduled delivery time are the same as in First Embodiment.

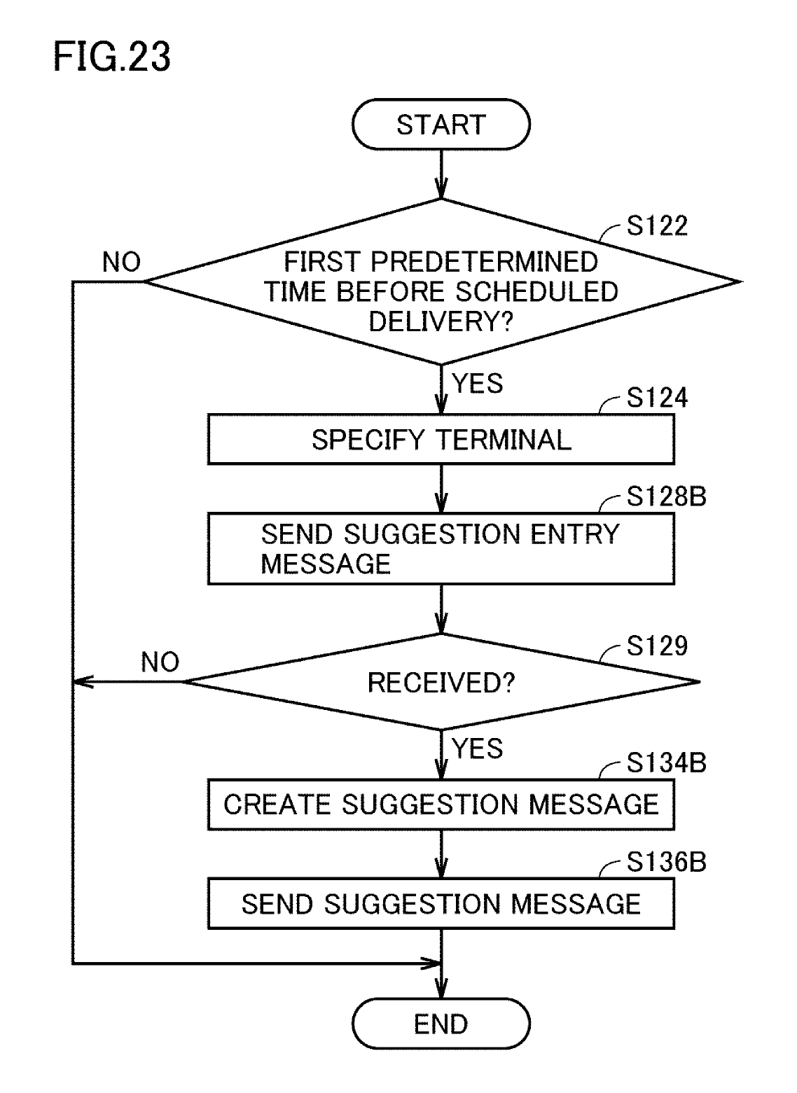

In the present embodiment, the CPU 110 of the server 100 additionally refers to the terminal data 121, and determines the presence or absence of a customer communication terminal 200 that has reached a first predetermined time, for example, 2 hours before the scheduled delivery time (step S122), as shown in FIG. 23. The CPU 110 puts itself on standby for the next timing in the absence of a customer communication terminal 200 that has reached a first predetermined time before the scheduled delivery time (NO in step S122).

The CPU 110 specifies the customer communication terminal 200 (step S124) in the presence of a customer communication terminal 200 that has reached a first predetermined time before the scheduled delivery time (YES in step S122). Page data for entry of products and services to be suggested is then sent from the CPU 110 to the store communication terminal 300 of the store associated with the communication terminal, via the communication interface 160 (step S128B).

By using the data from the server 100, the CPU 310 of the store communication terminal 300 makes the display 330 display a page for entry of products and services to be suggested to a user of interest, as shown in FIG. 22. Upon entry of products and services to be suggested to a user, the CPU 310 sends the data to the server 100 via the communication interface 360.

Referring back to FIG. 23, upon receiving the specified products and services from the store communication terminal 300 via the communication interface 160 (YES in step S129), the CPU 110 creates a suggestion message that suggests the products and services to a user, using the specified information from the store (step S134B). The CPU 110 sends the suggestion message to the customer communication terminal 200 via the communication interface 160 (step S136B). The CPU 110 puts itself on standby for the next timing.

In this manner, the customer communication terminal 200 can ask a user to place an order for products and services suited for the user, as shown in FIG. 16.

### Seventh Embodiment

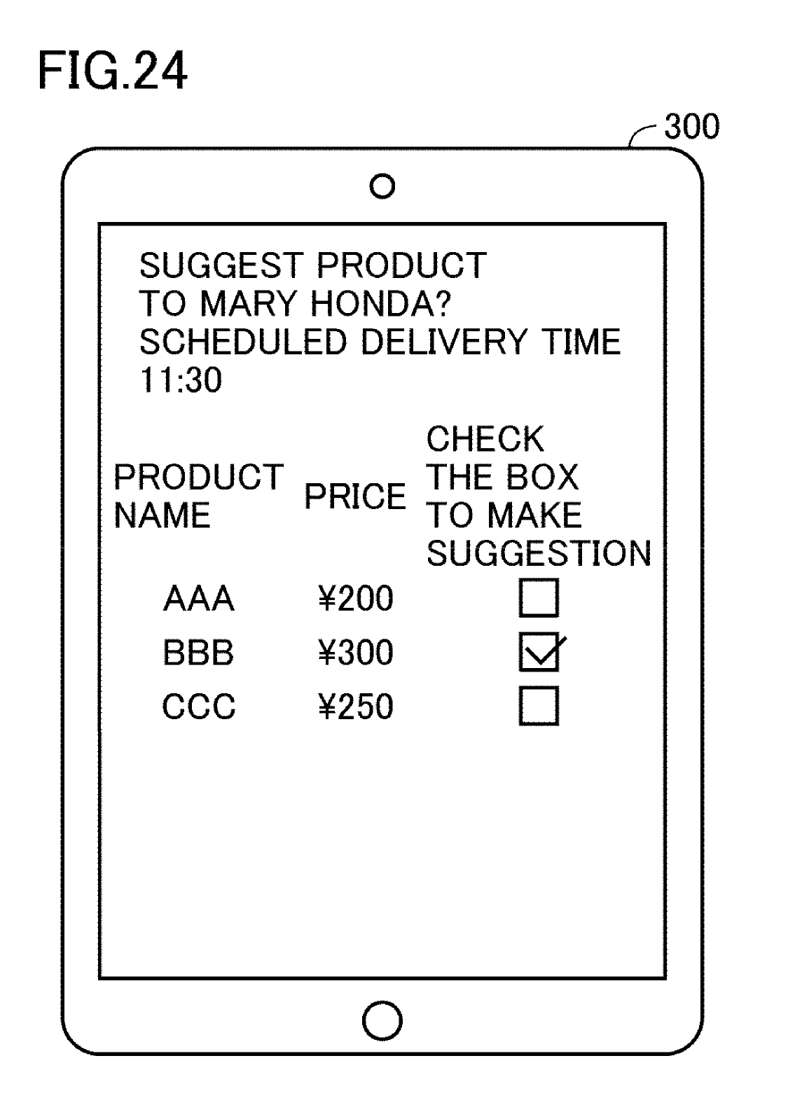

The server 100, by using information such as previous purchases of a user, availability of products and services in a store, and use-by dates, may allow the store communication terminal 300 to selectably suggest products and services to a user. For example, as shown in FIG. 24, the store communication terminal 300, by using data from the server 100, selectably displays products and services that are likely to be ordered by a user. The processes after reaching the scheduled delivery time are the same as in First Embodiment.

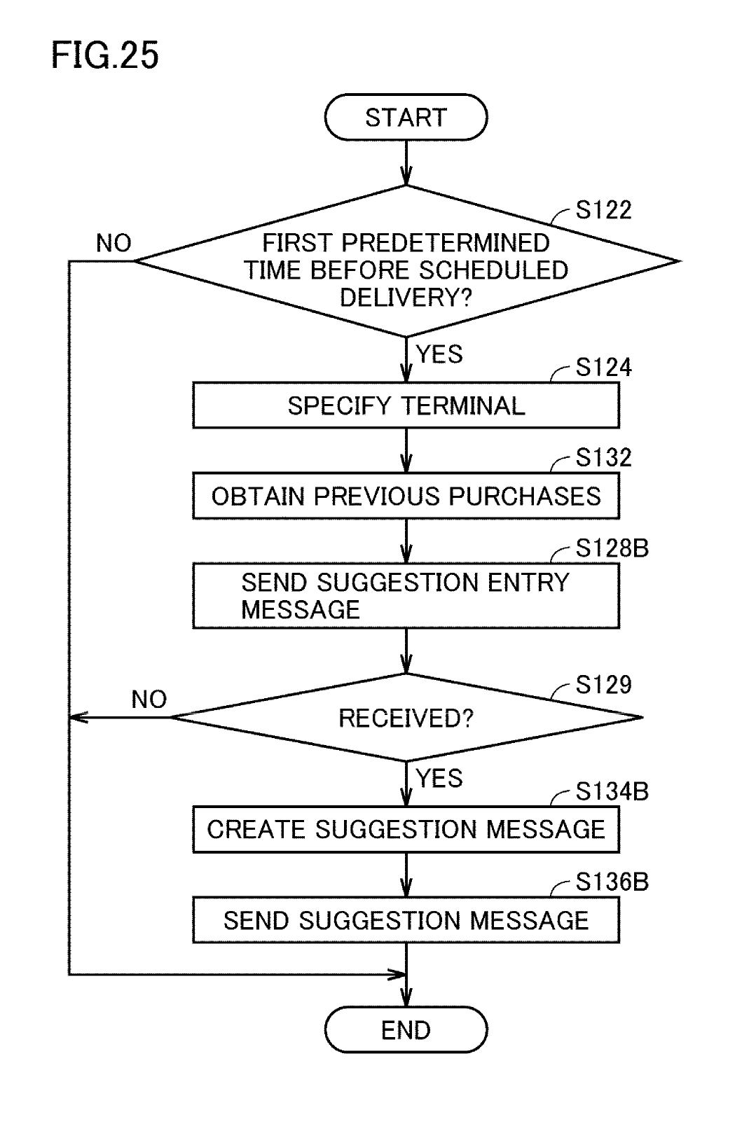

In the present embodiment, the CPU 110 of the server 100 additionally refers to the terminal data 121, and determines the presence or absence of a customer communication terminal 200 that has reached a first predetermined time, for example, 2 hours before the scheduled delivery time (step S122), as shown in FIG. 25. The CPU 110 puts itself on standby for the next timing in the absence of a customer communication terminal 200 that has reached a first predetermined time before the scheduled delivery time (NO in step S122).

The CPU 110 specifies the customer communication terminal 200 (step S124) in the presence of a customer communication terminal 200 that has reached a first predetermined time before the scheduled delivery time (YES in step S122. By referring to the order data 125, the CPU 110 obtains previous purchases of the user of the customer communication terminal 200 (step S132). By using the previous purchases, the CPU 110 creates page data for entry of a selection instruction for products and services that a user may like, and sends the data to the store communication terminal 300 of the store associated with the customer communication terminal 200 (step S128B). Preferably, the CPU 110, by referring to the feedback data 126, may send a suggestion to a staff member of the store for products and services that may match the taste of the user of the customer communication terminal 200 of interest.

The page data sent in step S128B from the CPU 110 to the store communication terminal 300 of the store associated with the customer communication terminal 200 may be page data created from the stock data 124 for entry of a selection instruction for high-stock products in the store associated with the user, or page data created from the stock data 124 for entry of a selection instruction for products having close use-by dates.

The subsequent processes are the same as in Sixth Embodiment, and will not be described.

### Eighth Embodiment

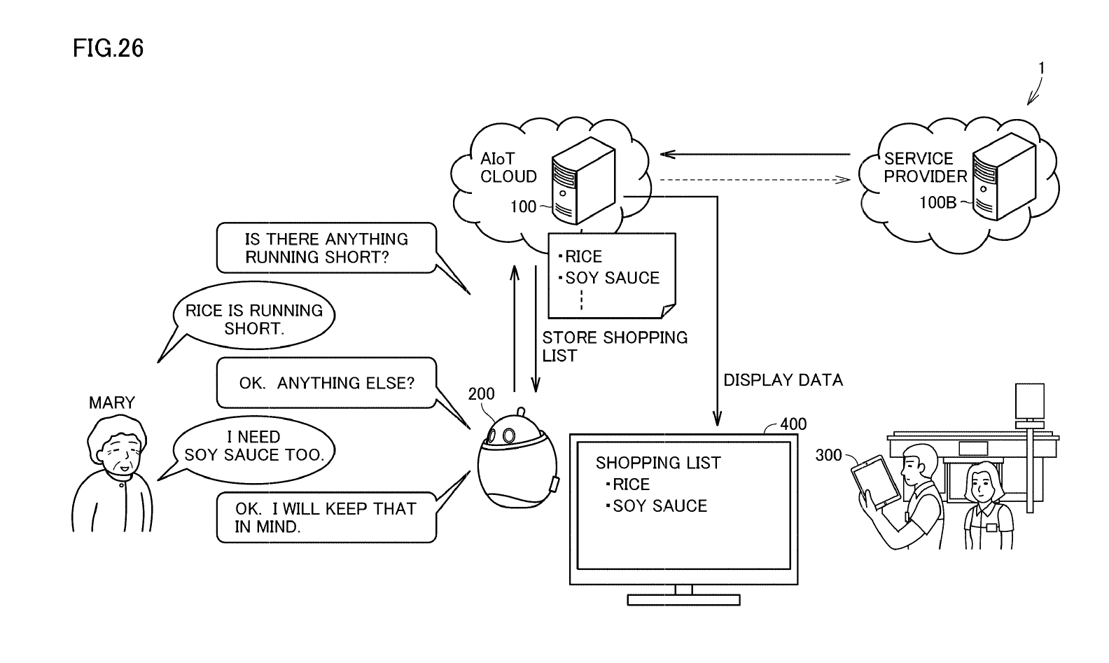

In addition to the techniques of First to Seventh Embodiments, the present embodiment uses a television 400 that displays a video near the customer communication terminal 200 to help assist a user by providing additional reference information. As used herein, the term “video” refers to images typically displayed by various types of image display devices such as displays and projectors, and the term “image” used throughout this specification, including the claims, is not limited to video, and includes all forms of images, including static images and moving images, and texts displayed in such devices. For example, as shown in FIG. 26, the television 400 displays a list of the products entered by a user through the customer communication terminal 200.

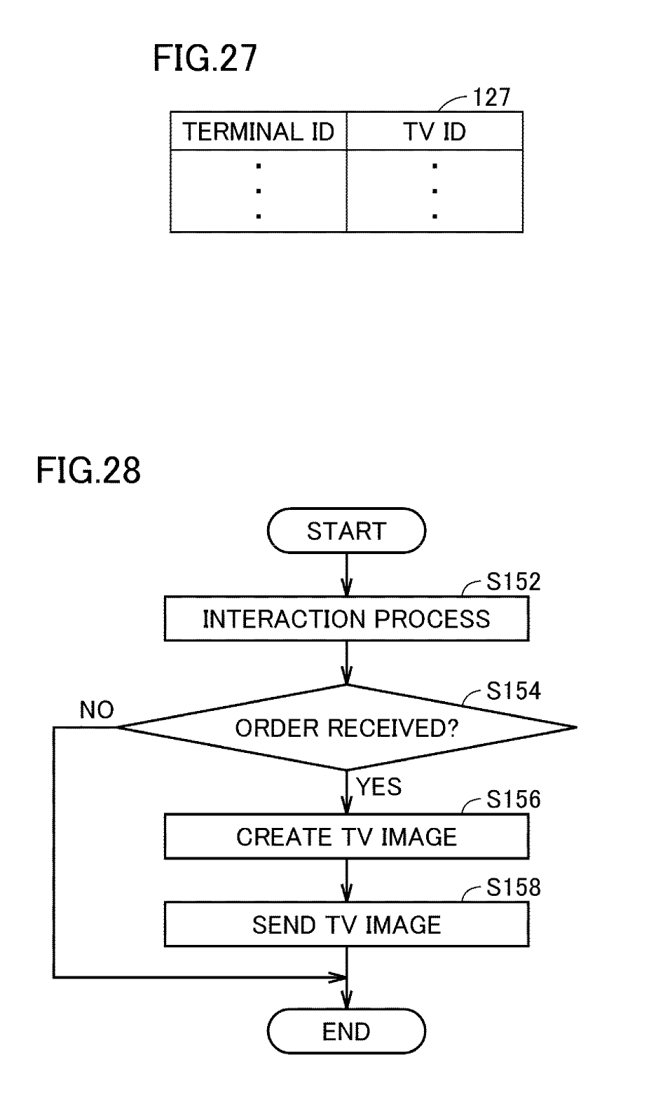

In the present embodiment, the memory 120 of the server 100 stores nearby display data 127 as shown in FIG. 27. The nearby display data 127 includes the association between customer communication terminals 200 and nearby televisions 400 established through, for example, user registration or Bluetooth™ pairing.

In the present embodiment, the CPU 110 of the server 100 performs the processes of FIG. 28. The CPU 110, via the communication interface 160 enables the customer communication terminal 200, for example, a robot, to start a voice interaction with a user (step S152). Upon accepting an order for products and services from a user (YES in step S154, the CPU 110 creates a television image for the order (step S156). The CPU 110 sends the television image to the television 400 associated with the customer communication terminal 200, via the communication interface 160.

In response, the user's television 400 displays the user's order for products and services entered by voice input, as shown in FIG. 26. The user can then start a voice interaction with the customer communication terminal 200 by watching the information displayed on the television 400.

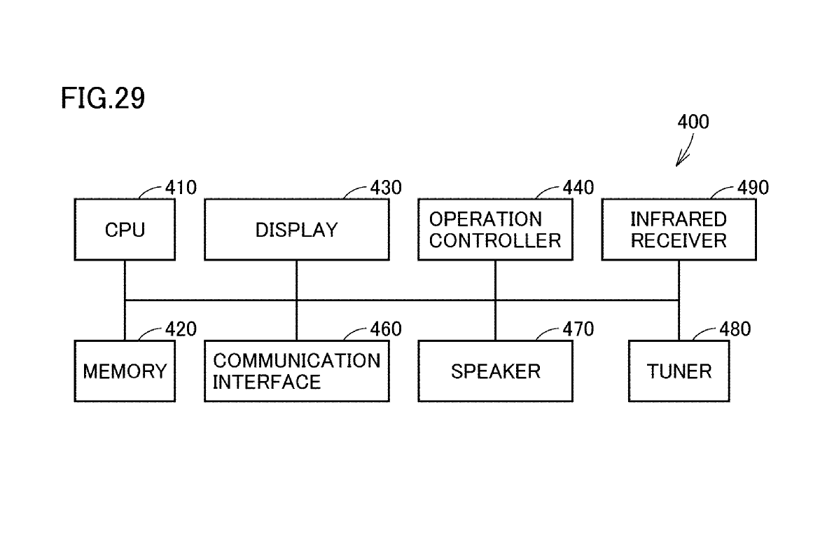

As shown in FIG. 29, the main constituting elements of the television 400 include a CPU 410, a memory 420, a display 430, an operation controller 440, a communication interface 460, a speaker 470, a tuner 480, and an infrared receiver 490.

The CPU 410 controls different parts of the television 400 by executing the programs stored in the memory 420 or in an external storage medium.

The memory 420 is realized by, for example, various types of RAMs and ROMs. The memory 420 stores various data, including device activation programs, interaction programs, and other programs run by the CPU 410, data generated by execution of programs by the CPU 410, data received from other servers, and input data via the operation controller 440.

The display 430 outputs various videos, including television broadcasting. The display 430 also outputs information such as texts and images from the server 100, using signals from the CPU 410. The display 430 may be a plurality of LED lights.

The operation controller 440 is realized by, for example, buttons, and a touch panel. The operation controller 440 accepts user instructions, and inputs the instructions to the CPU 410. The display 430 and the operation controller 440 may constitute a touch panel.

The communication interface 460 is realized by a communication module such as wireless LAN communications, and cat a wired LAN. The communication interface 460 enables data exchange with other devices, including the server 100 for interaction service, via wired or wireless communications.

The speaker 470 outputs various audios, including television broadcasting. The CPU 410 causes the speaker 470 to output an audio based on audio data received from the server 100 via the communication interface 460.

### Ninth Embodiment

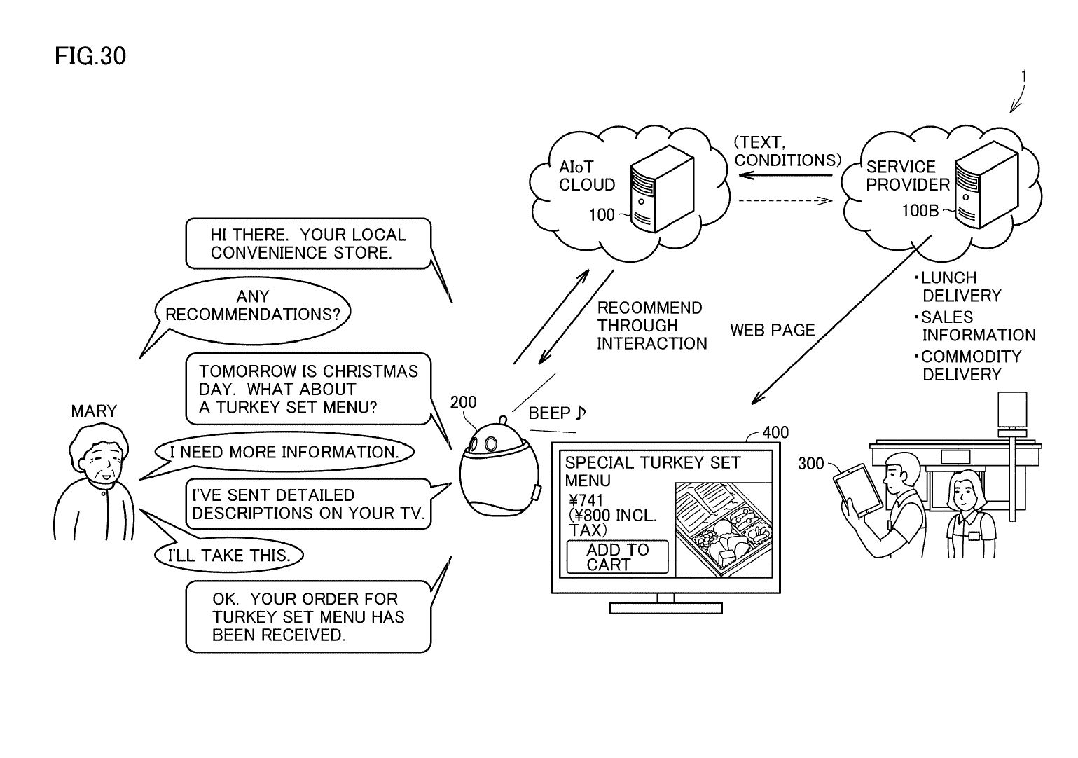

In Eighth Embodiment, the server 100 sends video data to the television 400. However, as shown in FIG. 30, the television 400 may obtain an image from a web page of a different server 100B.

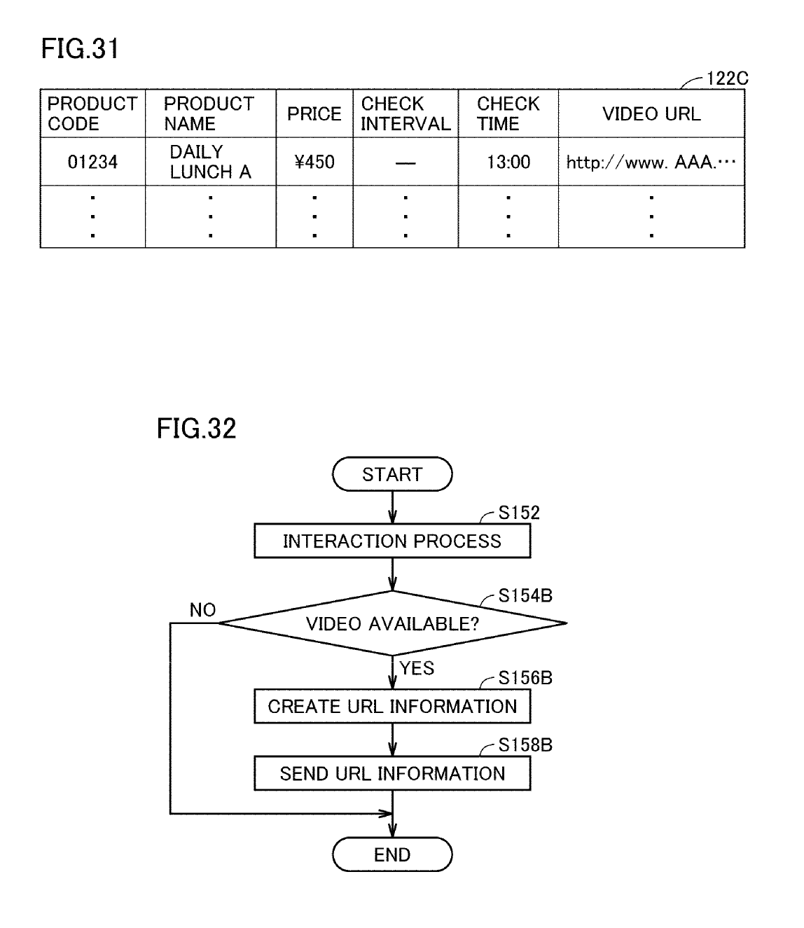

For example, the memory 120 of the server 100 stores product data 122C as shown in FIG. 31. The product data 122C contains product codes, product names, product prices, the time before asking a user for a review after the purchase, the time for asking a user for a review, and URL information of pages containing product details. These are associated with one another, and are stored for each product.

In the present embodiment, the CPU 110 of the server 100 performs the processes of FIG. 32. The CPU 110, via the communication interface 160, enables the customer communication terminal 200, for example, a robot, to start a voice interaction with a user (step S152). By referring to the product data 122C, the CPU 110 determines whether detailed product information concerning the interaction is available (step S154B).

If a video corresponding to the product of interest is available, the CPU 110 creates corresponding URL information (step S156B), and sends the URL information to the television 400 associated with the customer communication terminal 200, via the communication interface 160 (step S158B). By using the URL information, the television 400 receives and displays detailed information of the product, including images.

### Tenth Embodiment

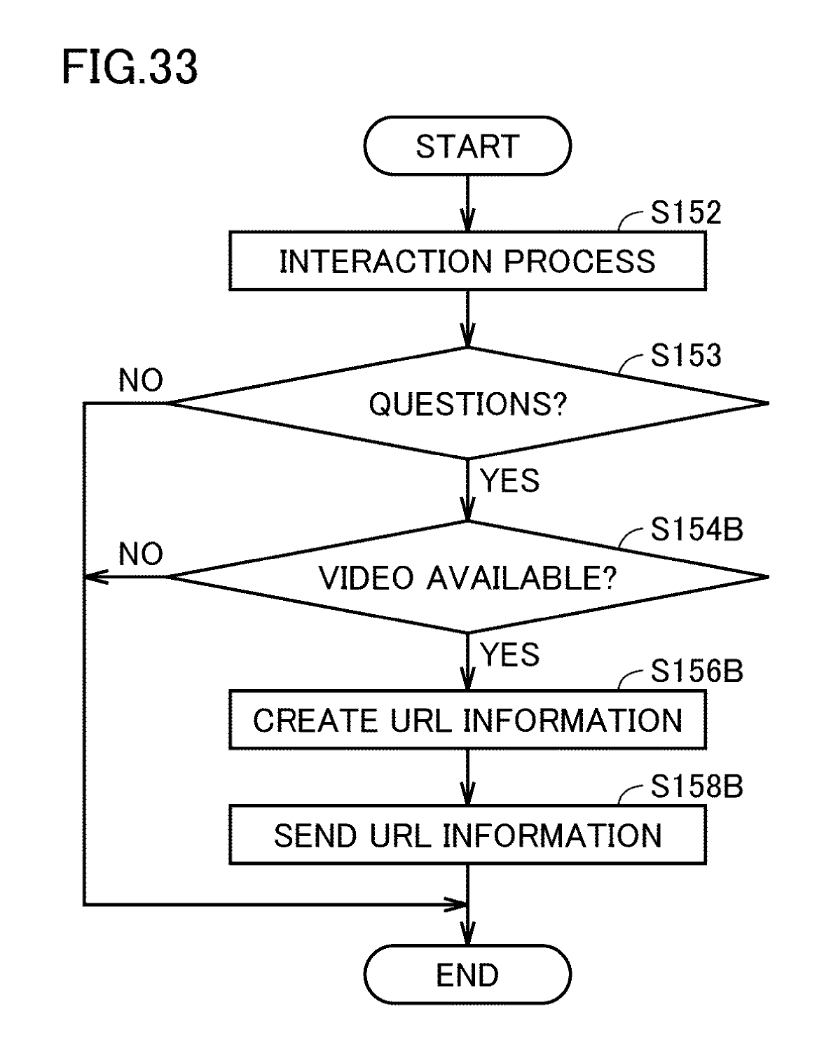

In another embodiment, as shown in FIG. 33, the television 400 near the customer communication terminal 200 may display a reference image to help assist the user when the user has asked a question via the customer communication terminal 200, for example, a robot.

Specifically, in the present embodiment, the CPU 110 of the server 100 performs the processes of FIG. 33. The CPU 110, via the communication interface 160, enables the customer communication terminal 200, for example, a robot, to start a voice interaction with a user (step S152). When the user has asked a question (YES in step S153), the CPU 110 refers to the product data 122C, and determines whether detailed information for the product of interest is available (step S154B).

If a video corresponding to the product of interest is available, the CPU 110 creates corresponding URL information (step S156B), and sends the URL information to the television 400 associated with the customer communication terminal 200, via the communication interface 160 (step S158B). By using the URL information, the television 400 receives and displays detailed information of the product, including images.

### Eleventh Embodiment

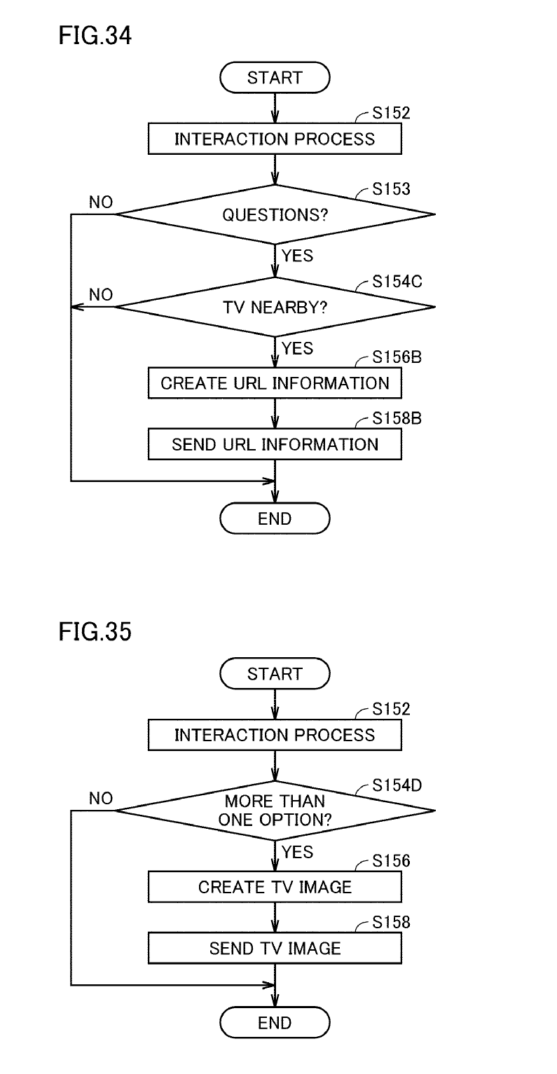

In another embodiment, as shown in FIG. 34, the television 400 may display a reference image when the customer communication terminal 200 is nearby.

Specifically, in the present embodiment, the CPU 110 of the server 100 performs the processes of FIG. 34. The CPU 110, via the communication interface 160, enables the customer communication terminal 200, for example, a robot, to start a voice interaction with a user (step S152). When the user has asked a question (YES in step S153), the CPU 110 determines, via the communication interface 160, whether the television 400 is near the customer communication terminal 200, for example, a robot (step S154C).

For example, the CPU 110 turns on a television or changes channels by causing the customer communication terminal 200 to send a signal for controlling the power button or channel buttons (YES in step S154C). The CPU 110 then creates corresponding URL information (step S156B), and sends the URL information to the television 400 associated with the customer communication terminal 200, via the communication interface 160 (step S158B). By using the URL information, the television 400 receives and displays detailed information of the product, including images.

### Twelfth Embodiment

In another embodiment, as shown in FIG. 35, the server 100 may display a reference image on the television 400 when a user has more than one option to choose from. Specifically, the television 400 displays more than one option when a user is expected to have trouble choosing the necessary information from the audio alone.

Specifically, in the present embodiment, the CPU 110 of the server 100 performs the processes of FIG. 35. The CPU 110, via the communication interface 160, enables the customer communication terminal 200, for example, a robot, to start a voice interaction with a user (step S152). The CPU 110 determines whether there is a need to present more than one option to the user (step S154D). When more than one option needs to be presented to the user (YES in step S154D), the CPU 110 creates a television image for the order, using information of one of the options (step S156). The CPU 110, via the communication interface 160, then sends the television image to the television 400 associated with the user's communication terminal (step S158). Here, the CPU 110 preferably makes the television 400 also output an audio corresponding to the television image, via the communication interface 160.

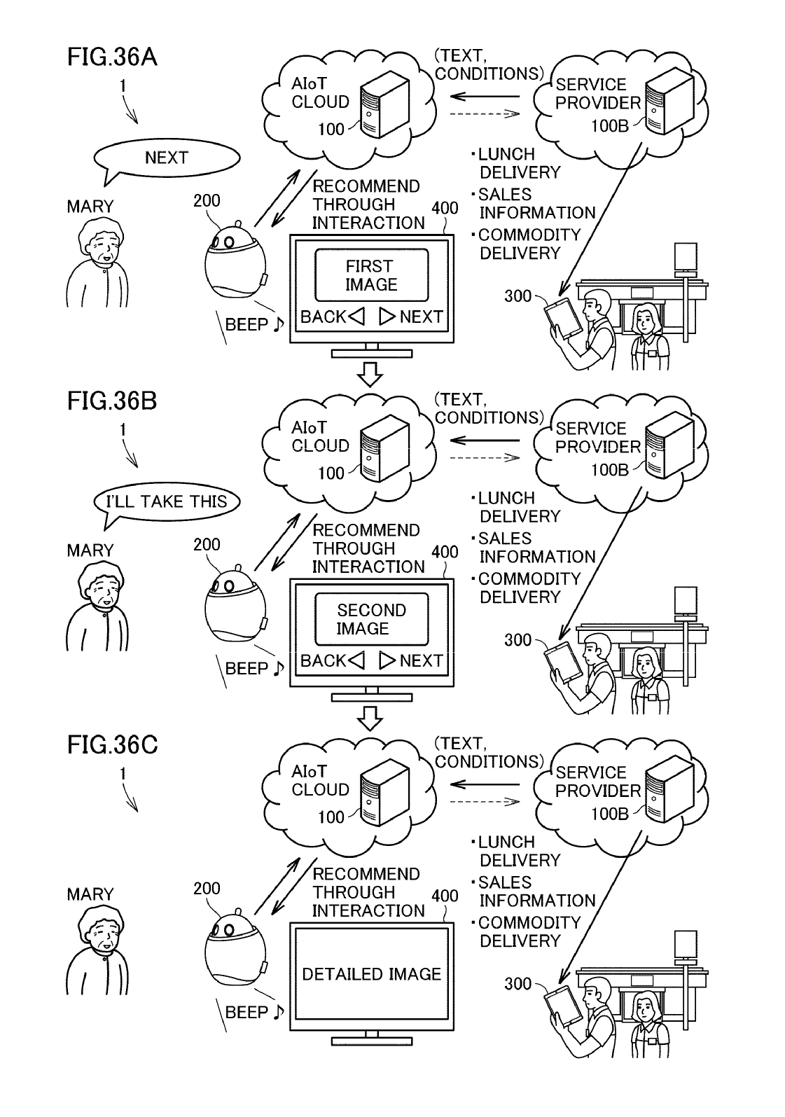

More specifically, in the present embodiment, when the user says the word “next” as shown in FIG. 36A, the CPU 110 of the server 100 receiving the audio from the customer communication terminal 200 causes the television 400 associated with the customer communication terminal 200 to display the next image from a plurality of options, via the communication interface 160, as shown in FIG. 36B. Here, the CPU 110 preferably makes the television 400 also output an audio corresponding to this image, via the communication interface 160. In response to the user having entered a product or service of his or her choice through the audio from the customer communication terminal 200, the CPU 110 of the server 100 receives the user's instruction for his or her choice, and displays a detailed image of the product in the television 400, via the communication interface 160, as shown in FIG. 36C. Here, the CPU 110 preferably makes the television 400 also output an audio corresponding to the detailed image of the product, via the communication interface 160.

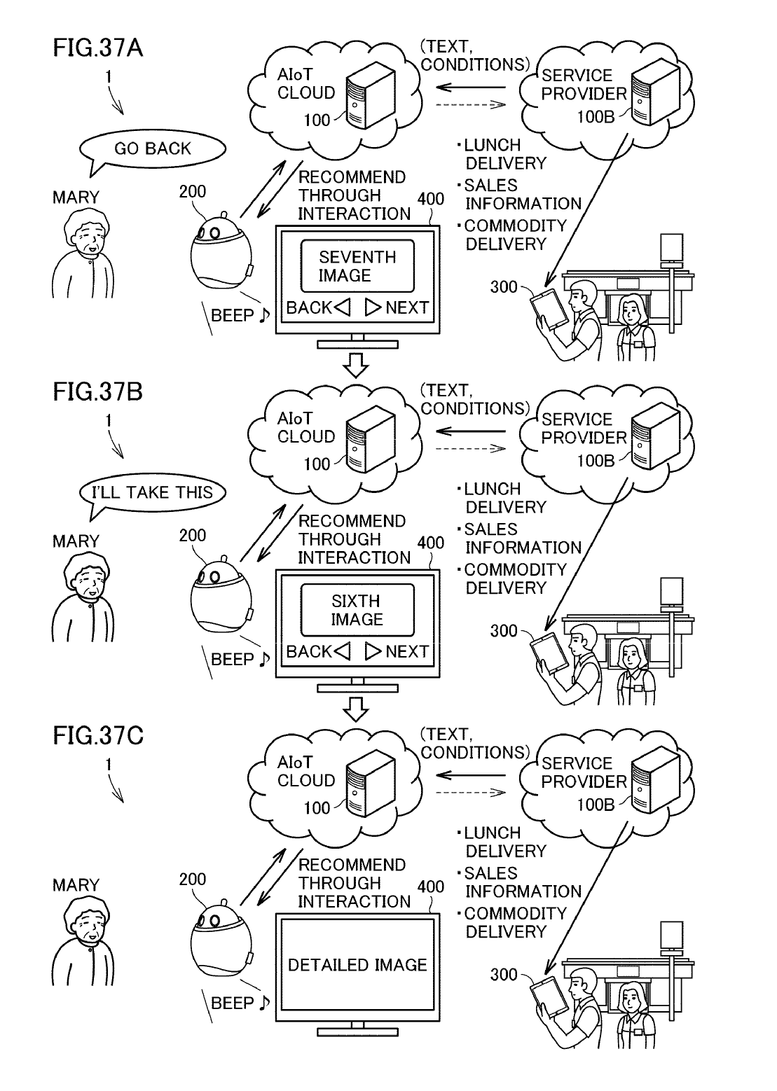

Conversely, when the user says the word “back” as shown in FIG. 37A, the CPU 110 of the server 100 receiving the audio via the customer communication terminal 200 causes the television 400 associated with the customer communication terminal 200 to display the previous image from a plurality of options, via the communication interface 160, as shown in FIG. 37B. Here, the CPU 110 preferably makes the television 400 also output an audio corresponding to this image, via the communication interface 160. In response to the user having entered a product or service of his or her choice through the audio from the customer communication terminal 200, the CPU 110 of the server 100 receives the user's instruction for his or her choice, and displays a detailed image of the product in the television 400, via the communication interface 160, as shown in FIG. 37C. Here, the CPU 110 preferably makes the television 400 also output an audio corresponding to the detailed image of the product, via the communication interface 160.

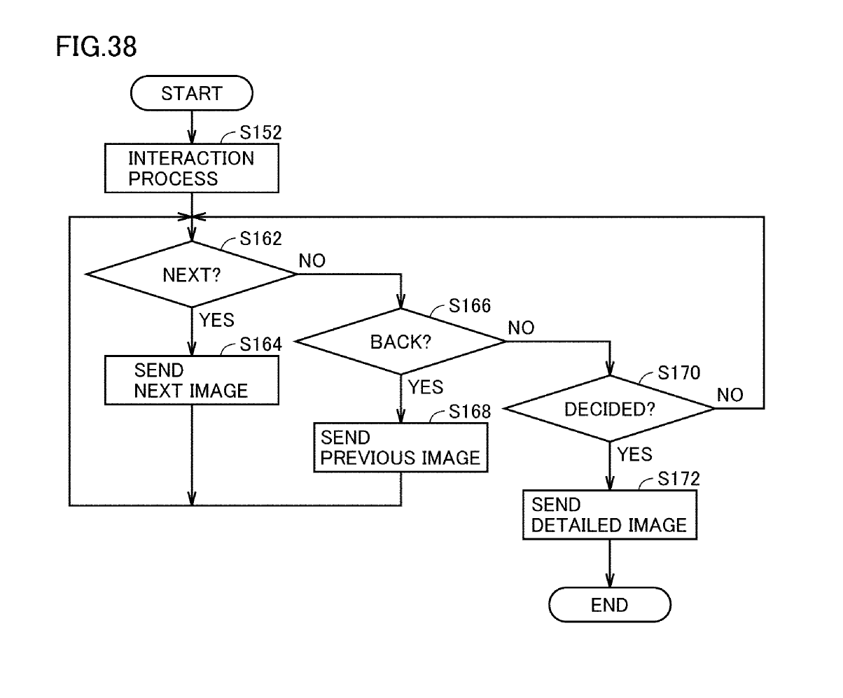

To describe more specifically, in the present embodiment, the CPU 110 of the server 100 performs the processes of FIG. 38. The CPU 110, via the communication interface 160, enables the customer communication terminal 200, for example, a robot, to start a voice interaction with a user (step S152). Upon receiving the word “next” (YES in step S162), the CPU 110 sends data of the next image from a plurality of options to the television 400 associated with the customer communication terminal 200, for example, a robot, via the communication interface 160, together with audio data corresponding to the image (step S164).

When there is no input of the word “next” (NO in step S162), the CPU 110, upon receiving the word “back” (YES in step S166), sends data of the previous image from a plurality of options to the television 400 associated with the customer communication terminal 200, for example, a robot, via the communication interface 160, together with audio data corresponding to the image (step S168).

When there is no input of the word “back” (NO in step S166), the CPU 110 determines whether the final instruction has been received from the user via the communication interface 160 (step S170). Upon receiving the final instruction from the user (YES in step S172), the CPU 110 sends a detailed image of the product or service to the television 400 associated with the customer communication terminal 200, for example, a robot, via the communication interface 160, together with audio data corresponding to the detailed image (step S172).

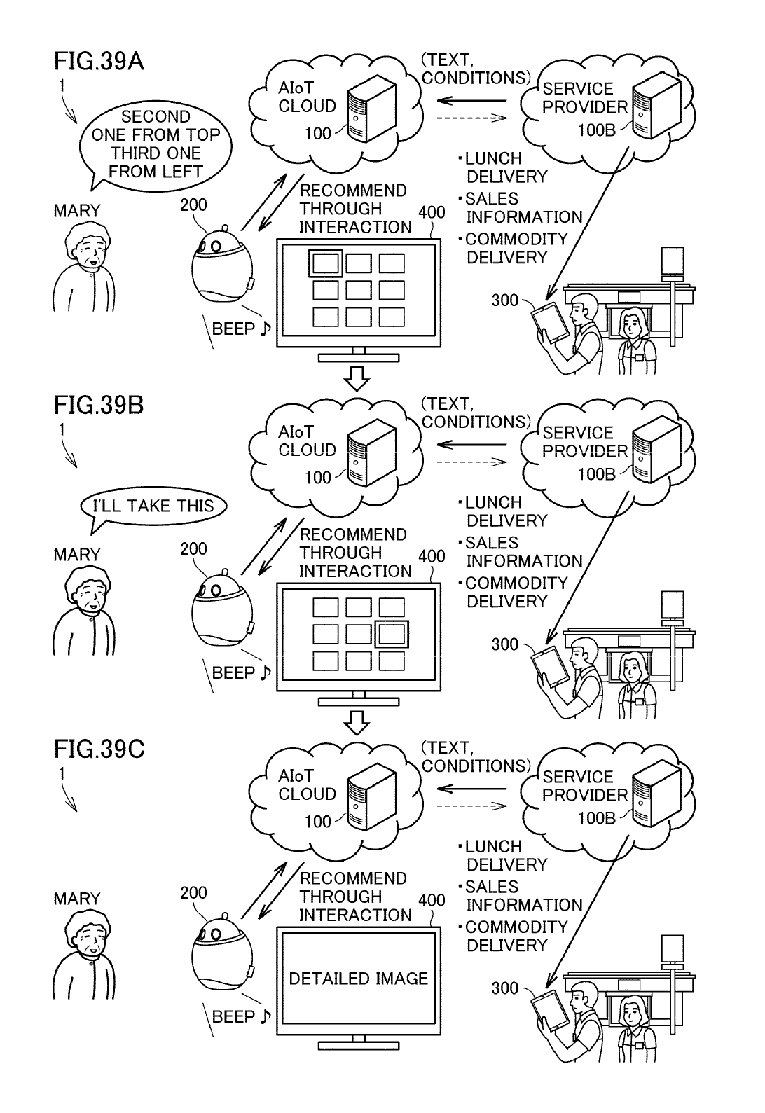

A user may choose a product or service from a plurality of options in the manner shown in FIGS. 39A to 39C. Specifically, the CPU 110 of the server 100 sends images of a plurality of options to the television 400 associated with the customer communication terminal 200, for example, a robot, via the communication interface 160. In response to the instruction from the server 100, the television 400 selectably displays the options in the form of a matrix, as shown in FIG. 39A. When the user has specified an image by specifying its position from the top (or from the bottom) and from the left (or from the right), the specified image is displayed in a different form, as shown in FIG. 39B.

In response to the user having entered a product or service of his or her choice through the audio from the customer communication terminal 200 by voice, the CPU 110 of the server 100 receives the user's instruction for his or her choice, and displays a detailed image of the product in the television 400, via the communication interface 160, as shown in FIG. 39C. Here, the CPU 110 preferably makes the television 400 also output an audio corresponding to the detailed image of the product, via the communication interface 160.

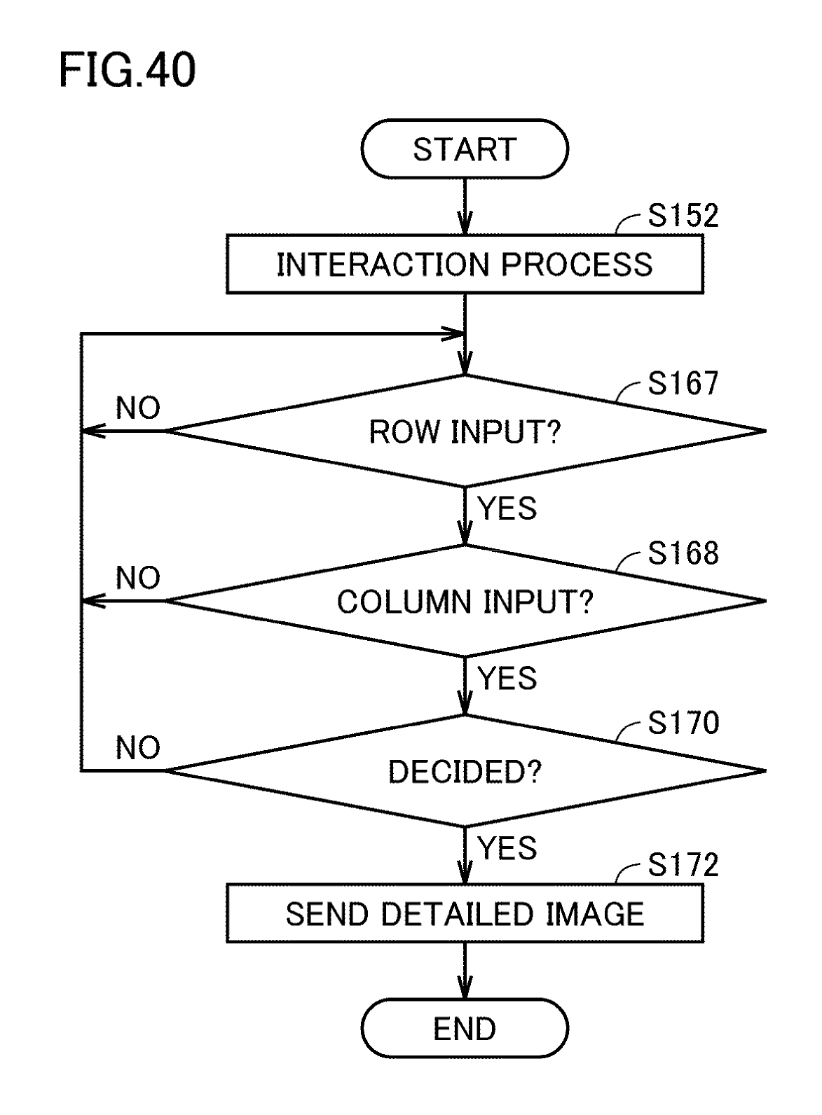

To describe more specifically, in the present embodiment, the CPU 110 of the server 100 performs the processes of FIG. 40. The CPU 110, via the communication interface 160, enables the customer communication terminal 200, for example, a robot, to start a voice interaction with a user (step S152). The CPU 110, via the communication interface 160, waits for input of a specified vertical position (i.e., a row) (step S167). Upon receiving the specified vertical position (YES in step S167), the CPU 110 waits for input of a specified horizontal position (i.e., a column) via the communication interface 160 (step S168).

Upon receiving the specified horizontal position (YES in step S168), the CPU 110 waits for input of a final instruction from the user (step S170). Upon receiving a final instruction (YES in step S170), the CPU 110 sends a detailed image of the product or service to the television 400 associated with the customer communication terminal 200, for example, a robot, via the communication interface 160, together with audio data corresponding to the detailed image (step S172).

The option images may be arranged in a single row, and the audio instruction may specify a position from the right or left. Alternatively, the option images may be arranged in a single column, and the audio instruction may specify a position from the top or bottom.

### Thirteenth Embodiment

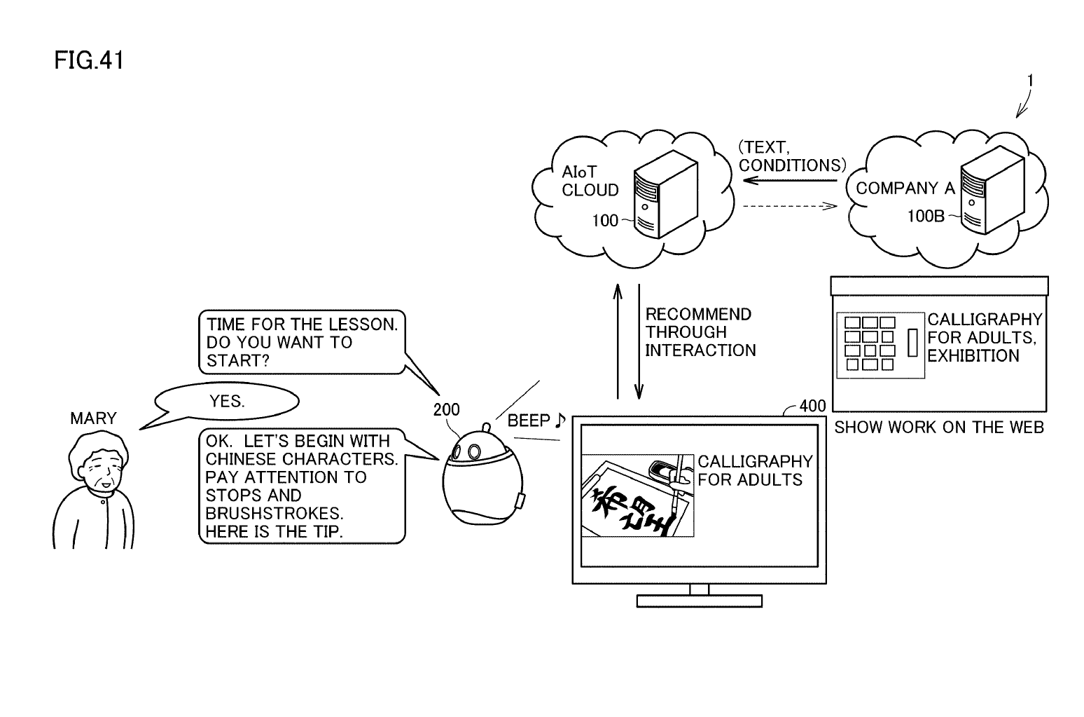

In Eighth to Twelfth Embodiments, a user enters an order for products and services through a voice interaction. However, the invention is not limited to such an embodiment. For example, as shown in FIG. 41, when outputting various audio lectures to a user through the customer communication terminal 200, for example, a robot, the server 100 may display an image concerning the lecture in the television 400 disposed nearby. That is, in this embodiment, the customer communication terminal 200 acts as a coach while the television 400 outputs a video that serves as a visual reference.

In this case, the memory 120 stores audio data and video data for lectures by associating these data with each other. The CPU 110 feeds the video data to the television 400 via the communication interface 160 as the audio data progresses, or feeds the audio data to the customer communication terminal 200 via the communication interface 160 as the video data progresses.

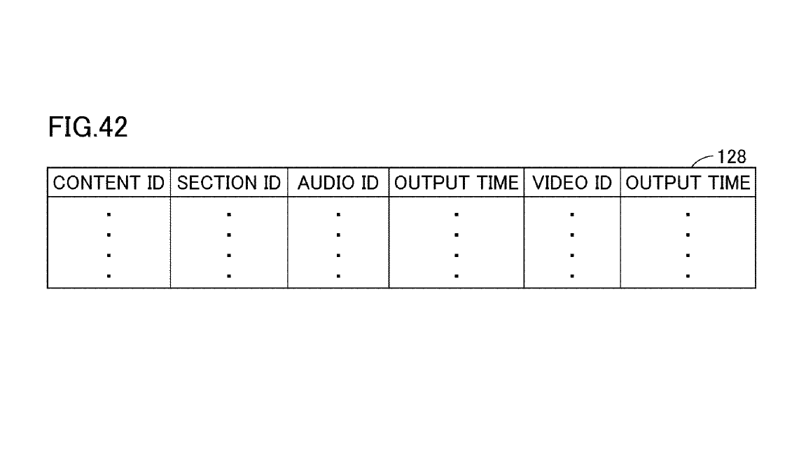

For example, the memory 120 stores the audio-video data 128 shown in FIG. 42. The audio-video data 128 contains content IDs, section IDs, audio IDs, audio output times, video IDs, and video output times. These are associated with one another, and are stored for each section of content. By referring to the audio-video data 128, the CPU 110 feeds audio data to the customer communication terminal 200 via the communication interface 160 while feeding video data associated with the audio data to the television 400 associated with the customer communication terminal 200, via the communication interface 160.

In a preferred embodiment, the server 100 displays, for example, still images, moving images, and texts that complement the descriptions provided by the audio through the customer communication terminal 200, for example, a robot, and these are displayed on a display, a projector, or the like associated with the customer communication terminal 200. For example, it might be useful to display a map when the user might find it difficult to find locations from the audio alone, or pictures of politicians or celebrities when the user might have difficulty remembering their faces from audio news alone.

### Fourteenth Embodiment

The server 100, the customer communication terminal 200, and the store communication terminal 300 are not limited to the structures, the functions, and the operations described in First to Thirteenth Embodiments, and, for example, the role of an individual device may be assigned to different devices, for example, other servers and databases. Conversely, the roles of different devices may be served by a single device, either in part or as a whole.

### Review

The foregoing embodiments provide a network system 1 that includes a first terminal 200 that includes a speaker 270, a second terminal 400 that includes a display 430, and a server 100 that outputs an audio to the first terminal 200, and displays an image concerning the audio in the second terminal 400.

Preferably, the second terminal 400 has access to more than one image concerning the audio. The server 100 causes the second terminal 400 to display a plurality of images concerning the audio one after another, every time the server 100 receives a first instruction from a user via the first terminal 200.

Preferably, the server 100 causes the second terminal 400 to display a plurality of images concerning the audio one after another in the reversed order, every time the server 100 receives a second instruction from a user via the first terminal 200.

Preferably, the server causes the second terminal to output an audio corresponding to the image based on the second instruction.

Preferably, the second terminal 400 has access to more than one image concerning the audio. The server 100 causes the second terminal 400 to selectably and orderly display a plurality of images concerning the audio.

Preferably, the server 100 receives, via the first terminal 200, an audio instruction specifying a position from left or right, and/or a position from top or bottom, and causes the second terminal 400 to display a detailed image concerning one of the images.

Preferably, the server causes the second terminal to output an audio corresponding to the detailed image.

Preferably, the server 100 causes the first terminal 200 to output a lecture audio, and causes the second terminal 400 to display an image that provides descriptions concerning the audio.

The foregoing embodiments provide an information processing method for the network system 1. The method includes the server 100 causing the first terminal 200 to output an audio, and the server 100 causing the second terminal 400 to display an image concerning the audio.

The foregoing embodiments provide a server 100 that includes a communication interface 160 for communication with the first and second terminals 200 and 400, and a processor 110 that causes the first terminal 200 to output an audio, and that causes the second terminal 400 to display an image concerning the audio, using the communication interface 160.

The foregoing embodiments provide an information processing method for the server 100 that includes a communication interface 160 for communicating with the first and second terminals 200 and 400, and a processor 110. The information processing method includes the processor 110 causing the first terminal 200 to output an audio using the communication interface 160, and the processor 110 causing the second terminal 400 to display an image concerning the audio using the communication interface 160.

### Examples of Other Applications

As is evident, the present invention also can be achieved by supplying a program to a system or a device. The advantages of the present invention also can be obtained with a computer (or a CPU or an MPU) in a system or a device upon the computer reading and executing the program code stored in the supplied storage medium (or memory) storing software programs intended to realize the present invention.

In this case, the program code itself read from the storage medium realizes the functions of the embodiments above, and the storage medium storing the program code constitutes the present invention.

Evidently, the functions of the embodiments above can be realized not only by a computer reading and executing such program code, but by some or all of the actual processes performed by the OS (operating system) or the like running on a computer under the instructions of the program code.

The functions of the embodiments above also can be realized by some or all of the actual processes performed by the CPU or the like of an expansion board or expansion unit under the instructions of the program code read from a storage medium and written into other storage medium provided in the expansion board inserted into a computer or the expansion unit connected to a computer.

The embodiments disclosed herein are to be considered in all aspects only as illustrative and not restrictive. The scope of the present invention is to be determined by the scope of the appended claims, not by the foregoing descriptions and the invention is intended to cover all modifications falling within the equivalent meaning and scope of the claims set forth below.

What is claimed is:

1. A network system comprising:
a first terminal that includes a speaker;
a second terminal that includes a display; and
a server that causes the first terminal to output an audio, and that causes the second terminal to display an image concerning the audio.

2. The network system according to claim 1, wherein:
the second terminal has access to more than one image concerning the audio, and
the server causes the second terminal to display a plurality of images concerning the audio one after another, every time the server receives a first instruction from a user via the first terminal.

3. The network system according to claim 2, wherein:
the server causes the second terminal to display a plurality of images concerning the audio one after another in the reversed order, every time the server receives a second instruction from a user via the first terminal.

4. The network system according to claim 3, wherein the server causes the second terminal to output an audio corresponding to the image based on the second instruction.

5. The network system according to claim 1, wherein:
the second terminal has access to more than one image concerning the audio, and
the server causes the second terminal to selectably display a plurality of images concerning the audio.

6. The network system according to claim 5, wherein:
the server receives, via the first terminal, an audio instruction specifying a position from left or right, and/or a position from top or bottom, and causes the second terminal to display a detailed image concerning one of the images.

7. The network system according to claim 6, wherein the server causes the second terminal to output an audio corresponding to the detailed image.

8. The network system according to claim 1, wherein the server causes the first terminal to output a lecture audio, and causes the second terminal to display an image that provides descriptions concerning the audio.

9. A information processing method for a network system,
the method comprising:
the server causing the first terminal to output an audio; and
the server causing the second terminal to display an image concerning the audio.

10. A server comprising:
a communication interface for communicating with a first and a second terminal; and
a processor that causes the first terminal to output an audio, and that causes the second terminal to display an image concerning the audio, using the communication interface.

11. An information processing method for a server that includes: a communication interface for communicating with a first and a second terminal; and a processor,
the method comprising:
the processor causing the first terminal to output an audio using the communication interface; and
the processor causing the second terminal to display an image concerning the audio using the communication interface.
